(19) United States
(12) Patent Application Publication
(10) Pub. No.: US 2013/0287993 A1
(43) Pub. Date: Oct. 31, 2013

(54) COMPOSITE PRODUCTS MADE WITH BINDER COMPOSITIONS THAT INCLUDE TANNINS AND MULTIFUNCTIONAL ALDEHYDES

(71) Applicant: GEORGIA-PACIFIC CHEMICALS LLC, Atlanta, GA (US)

(72) Inventors: Bobby L. Williamson, Conyers, GA (US); Feng Jing, Snellville, GA (US); Derek L. Atkinson, Lawrenceville, GA (US)

(73) Assignee: GEORGIA-PACIFIC CHEMICALS LLC, Atlanta, GA (US)

(21) Appl. No.: 13/796,577

(22) Filed: Mar. 12, 2013

Related U.S. Application Data
(60) Provisional application No. 61/639,276, filed on Apr. 27, 2012.

(51) Int. Cl. B32B 21/02

(52) U.S. Cl. CPC B32B 21/02
USPC 428/106; 428/532; 428/537.1; 442/180; 428/426; 427/384

(57) ABSTRACT

Composite products and methods for making same are provided. The composite product can include a plurality of substrates and an at least partially cured binder composition. The binder composition, prior to curing, can include one or more tannins and one or more multifunctional aldehyde compounds. The one or more multifunctional aldehyde compounds can include (1) three or more carbon atoms and two or more aldehyde functional groups, or (2) two or more carbon atoms, at least one aldehyde functional group, and at least one functional group other than an aldehyde functional group. A carbon atom of at least one aldehyde functional group in the cured binder composition can have a first bond with a first tannin molecule and a second bond with (a) the first tannin molecule, (b) a second tannin molecule, or (c) an oxygen atom of the at least one aldehyde functional group.

### CROSS-REFERENCE TO RELATED APPLICATION

This application claims priority to U.S. Provisional patent application having Ser. No. 61/639,276, filed on Apr. 27, 2012, which is incorporated by reference herein.

### BACKGROUND

1. Field

Embodiments described herein generally relate to composite products made with binder compositions that include one or more tannins and one or more multifunctional aldehydes and methods for making and using same.

2. Description of the Related Art

The production of composite wood products and composite fiber products require a binder to bond the discrete wood particulates or fibers to one another. Such conventional binders contain formaldehyde, which can be harmful to humans and the environment. Such formaldehyde based binders include urea-formaldehyde (“UF”), melamine-formaldehyde (“MF”), phenol-formaldehyde (“PF”), melamine-urea-formaldehyde (“MUF”), and phenol-urea-formaldehyde resins (“PUF”). While these formaldehyde based binders produce composite wood products and composite fiber products having desirable properties, formaldehyde is released during the production of the binder, during cure of the composite product containing the binder, as well as, from the final composite products made using the binder.

Various alternative binders have been studied in an attempt to reduce the amount of formaldehyde based binder or completely replace the formaldehyde based binder altogether in the production of composite products. One type of binder that has been studied includes the use of tannins. The tannins can be combined with formaldehyde based binders to reduce the overall concentration of formaldehyde in the binder, used alone, or mixed with a hardener or curing agent such as hexamethylene tetramine, paraformaldehyde, silica, boric acid, or the like. These attempts to reduce formaldehyde emission, however, are accompanied with one or more undesirable effects such as binders that continue to emit more formaldehyde than desired, longer cure times, reduced shelf-life of the resin, reduced product strength, reduced tolerance for processing variations, and/or inferior moisture resistance.

There is a need, therefore, for improved binder compositions for making composite products having reduced or no formaldehyde emission.

### SUMMARY

Composite products made with binder compositions that include one or more tannins and one or more multifunctional aldehydes, and methods for making same are provided. The method for making the composite product can include contacting a plurality of substrates with a binder composition and at least partially curing the binder composition to provide the composite product. The binder composition can include one or more tannins and one or more multifunctional aldehyde compounds. The one or more multifunctional aldehyde compounds can include (1) three or more carbon atoms and two or more aldehyde functional groups, or (2) two or more carbon atoms, at least one aldehyde functional group, and at least one functional group other than an aldehyde functional group. A carbon atom of at least one aldehyde functional group in the cured binder composition can have a first bond with a first tannin molecule of the one or more tannins and a second bond with (a) the first tannin molecule, (b) a second tannin molecule of the one or more tannins, or (c) an oxygen atom of the at least one aldehyde functional group.

The composite product can include a plurality of substrates and an at least partially cured binder composition. The binder composition, prior to curing, can include one or more tannins and one or more multifunctional aldehyde compounds. The one or more multifunctional aldehyde compounds can include (1) three or more carbon atoms and two or more aldehyde functional groups, or (2) two or more carbon atoms, at least one aldehyde functional group, and at least one functional group other than an aldehyde functional group. A carbon atom of at least one aldehyde functional group in the cured binder composition can have a first bond with a first tannin molecule of the one or more tannins and a second bond with (a) the first tannin molecule, (b) a second tannin molecule of the one or more tannins, or (c) an oxygen atom of the at least one aldehyde functional group.

### DETAILED DESCRIPTION

It has been surprisingly and unexpectedly discovered that binder compositions containing one or more tannins, one or more multifunctional aldehyde compounds, and optionally one or more base compounds can be used to produce lignocellulose based and/or fiber based composite products having acceptable properties without the need for formaldehyde based binders or without the need for as much aldehyde based binders as previously required. In other words, the binder composition containing the one or more tannins and the one or more multifunctional aldehydes can be used alone to produce composite products or can be combined with one or more aldehyde based binders to provide a binder system containing less aldehyde compounds as compared to previous aldehyde based binders.

As used herein, the term “tannin” refers to both hydrolyzable tannins and condensed tannins. As such, the binder composition can include hydrolyzable tannins, condensed tannins, or a combination of hydrolyzable tannins and condensed tannins. Illustrative genera of shrubs and/or trees from which suitable tannins can be derived can include, but are not limited to, Acacia, Castanea, Vachellia, Senegalia, Terminalia, Phyllanthus, Caesalpinia, Quercus, Schinopsis, Tsuga, Rhus, Juglans, Carya, and Pinus, or any combination thereof. In another example, genera from which suitable tannins can be derived can include, but are not limited to, Schinopsis, Acacia, or a combination thereof. In another example, genera from which suitable tannins can be derived can include, but are not limited to, Pinus, Carya, or a combination thereof.

Hydrolyzable tannins are mixtures of simple phenols such as pyrogallol and ellagic acid and of esters of a sugar, e.g., glucose, with gallic and digallic acids. Illustrative hydrolyzable tannins can include, but are not limited to, extracts recovered from Castanea sativa, (e.g., chestnut), Terminalia and Phyllanthus (e.g., myrabalans tree species), Caesalpinia coriaria (e.g., divi-divi), Caesalpinia spinosa, (e.g., tara), algarobilla, valonea, and Quercus (e.g., oak). Condensed tannins are polymers formed by the condensation of flavans. Condensed tannins can be linear or branched molecules. Illustrative condensed tannins can include, but are not limited to Acacia mearnsii (e.g., wattle or mimosa bark extract), Schinopsis (e.g., quebracho wood extract), Tsuga (e.g., hemlock bark extract), Rhus (e.g., sumach extract), Juglans (e.g., walnut), Carya illinoinensis (e.g., pecan), and Pinus (e.g., Radiata pine, Maritime pine, bark extract species).

The condensed tannins include about 70 wt % to about 80 wt % active phenolic ingredients (the “tannin fraction”) and the remaining ingredients (the “non-tannin fraction”) can include, but are not limited to, carbohydrates, hydrocolloid gums, and amino and/or imino acid fractions. The condensed tannins can be used as recovered or extracted from the organic matter or the condensed tannins can be purified, e.g., to about 95 wt % or more active phenolic ingredients. Hydrolyzable tannins and condensed tannins can be extracted from the starting material, e.g., trees and/or shrubs, using well established processes. A more detailed discussion of tannins is discussed and described in the Handbook of Adhesive Technology, Second Edition, CRC Press, 2003, chapter 27, “Natural Phenolic Adhesives I: Tannin,” and in Monomers, Polymers and Composites from Renewable Resources, Elsevier, 2008, chapter 8, “Tannins: Major Sources, Properties and Applications.”

The condensed tannins can be classified or grouped into one of two main categories, namely, those containing a resorcinol unit and those containing a phloroglucinol unit. Illustrative tannins that include the resorcinol unit include, but are not limited to, black wattle tannins and quebracho tannins. The resorcinol unit can be represented by formula I below.

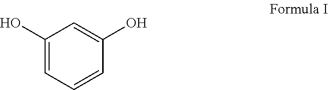

The resorcinol group is shown within the box overlaying the unit structure of black wattle and quebracho tannins in Formula II below. For simplicity, the structure of black wattle and quebracho tannins is represented by their flavonoid unit structure.

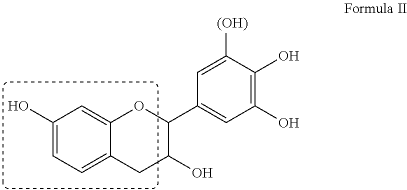

Illustrative tannins that include the phloroglucinol unit include, but are not limited to, pecan tannins and pine tannins. The phloroglucinol unit can be represented by Formula III below.

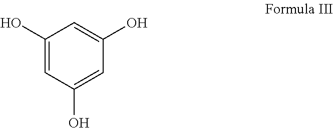

The phloroglucinol unit is shown within the box overlaying the unit structure of pecan and pine tannins in Formula IV below. For simplicity, the structure of pecan and pine tannins is represented by their flavonoid unit structure.

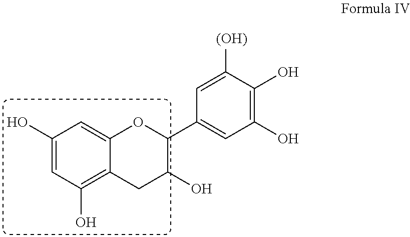

Phloroglucinol is known for higher reactivity than resorcinol. As such, tannins that include the phloroglucinol unit are more reactive than tannins that include the resorcinol unit.

If the binder composition includes a mixture of hydrolyzable tannins and condensed tannins any ratio with respect to one another can be used. For example, a binder composition that includes both hydrolyzable tannins and condensed tannins can have a concentration of condensed tannins from about 1 wt % to about 99 wt %, based on the combined weight of the hydrolyzable tannins and the condensed tannins. In another example, a binder composition that includes both hydrolyzable tannins and condensed tannins can have a concentration of condensed tannins of about 50 wt % or more, about 55 wt % or more, about 60 wt % or more, about 70 wt % or more, about 75 wt % or more, about 80 wt % or more, about 85 wt % or more, about 90 wt % or more, about 95 wt % or more, or about 97 wt % or more.

The tannins can have an acidic pH. For example, the pH of the tannins can be from a low of about 3, about 3.5, or about 4 to a high of about 5, about 5.5, or about 6. The tannins can have resorcinol or phloroglucinol functional groups that can react with aldehydes under appropriate conditions. Suitable, commercially available tannins can include, but are not limited to, black wattle tannin and quebracho tannin. Other suitable tannins can include pine tannin and pecan tannin.

If the binder composition includes two or more different tannins, the two or more tannins can have resorcinol unit or a phloroglucinol unit. For example, the binder composition can include two different tannins that each includes resorcinol units, e.g., qubracho tannins and black wattle tannins. In another example, the binder composition can include two different tannins, where a first tannin includes a resorcinol unit, e.g., black wattle tannin, and a second tannin includes a phloroglucinol unit, e.g., pine tannin. In another example, the binder composition can include two different tannins that each includes phloroglucinol units, e.g., pine tannins and pecan tannins.

If the binder composition includes a mixture of two different tannins, the two tannins can be present in any ratio with respect to one another. For example, a binder composition that includes a first tannin and a second tannin, where the first and second tannins are different from one another, can have a concentration of the first tannin in an amount from about 1 wt % to about 99 wt % and conversely about 99 wt % to about 1 wt % of the second tannin, based on the combined weight of the first and second tannins. In another example, the amount of the first tannin in a binder composition that includes a first and second tanning can be from a low of about 5 wt %, about 10 wt %, about 15 wt %, about 20 wt %, about 25 wt % about 30 wt %, about 35 wt %, about 40 wt %, or about 45 wt % to a high of about 60 wt %, about 65 wt %, about 70 wt %, about 75 wt %, about 80 wt %, about 85 wt %, about 90 wt %, or about 95 wt %, based on the combined weight of the first and second tannins. The binder composition can include any number of different tannins with the different tannins present in any desired amount.

As used herein, the terms “multifunctional aldehyde compound” and “multifunctional aldehyde” are used interchangeably and refer to compounds having at least two functional groups, with at least one of the functional groups being an aldehyde group. For example, the multifunctional aldehyde can include two or more aldehyde functional groups. In another example, the multifunctional aldehyde can include at least one aldehyde functional group and at least one functional group other than an aldehyde functional group. As used herein, the term “functional group” refers to reactive groups in the multifunctional aldehyde compound and can include, but are not limited to, aldehyde groups, carboxylic acid groups, ester groups, amide groups, imine groups, epoxide groups, aziridine groups, azetidinium groups, and hydroxyl groups.

The multifunctional aldehyde compound can include three or more carbon atoms and can have two or more aldehyde functional groups. For example, the multifunctional aldehyde compound can include three, four, five, six, or more carbon atoms and have two or more aldehyde functional groups. The multifunctional aldehyde can include two or more carbon atoms and have at least one aldehyde functional group and at least one functional group other than an aldehyde group such as a carboxylic acid group, an ester group, an amide group, an imine groups, an epoxide group, an aziridine group, an azetidinium group, and/or a hydroxyl group. For example, the multifunctional aldehyde can include two, three, four, five, six, or more carbon atoms and have at least one aldehyde functional group and at least one functional group other than an aldehyde group such as a carboxylic acid group, an ester group, an amide group, an imine groups, an epoxide group, an aziridine group, an azetidinium group, and/or a hydroxyl group.

Suitable bifunctional or difunctional aldehydes having two aldehyde (—CHO) functional groups can be represented by Formula V:

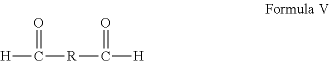

where R is a divalent aliphatic, cycloaliphatic, aromatic, or heterocyclic group having from 1 to 12 carbon atoms. Illustrative multi-functional aldehydes can include, but are not limited to, malonaldehyde, succinaldehyde, glutaraldehyde, 2-hydroxyglutaraldehyde, β-methylglutaraldehyde, adipaldehyde, pimelaldehyde, suberaldehyde, malealdehyde, fumaraldehyde, sebacaldehyde, phthalaldehyde, isophthalaldehyde, terephthalaldehyde, ring-substituted aromatic aldehydes, any combination thereof, or any mixture thereof.

Suitable multifunctional aldehydes that include an aldehyde group and at least one functional group other than an aldehyde group can include, but are not limited to, glyoxylic acid, glyoxylic acid esters, glyoxylic acid amides, 5-(hydroxymethyl)furfural, any combination thereof, or any mixture thereof. The aldehyde group in glyoxylic acid, for example, is usually not observed in solution or as a solid. As such, for a multifunctional aldehyde such as glyoxylic acid that has an aldehyde group and a carboxylic acid group, the aldehyde group can often exist as a hydrate and could be represented by the formula (HO)₂CHCO₂H. In other words, any form or derivative of a particular compound can be used to prepare the binder compositions discussed and described herein. For example, in the context of glyoxylic acid, glyoxylic acid, glyoxylic acid monohydrate, and/or glyoxylate can be combined with the tannins to produce the binder composition.

The carbon atom in at least one aldehyde functional group of the multifunctional aldehyde compound can bond with the tannin upon at least partial curing of the binder composition. As used herein, the terms “curing,” “cured,” and similar terms are intended to refer to the structural and/or morphological change that occurs in the binder composition as it is cured to cause covalent chemical reaction (crosslinking), ionic interaction or clustering, improved adhesion to the substrate, phase transformation or inversion, and/or hydrogen bonding. As used herein, the phrases “at least partially cure,” “at least partially cured,” and similar terms are intended to refer to a binder composition that has undergone at least some covalent chemical reaction (crosslinking), ionic interaction or clustering, improved adhesion to the substrate, phase transformation or inversion, and/or hydrogen bonding, but may also be capable of undergoing additional covalent chemical reaction (crosslinking), ionic interaction or clustering, improved adhesion to the substrate, phase transformation or inversion, and/or hydrogen bonding.

The carbon atom in at least one aldehyde functional group of the multifunctional aldehyde compound in the cured binder composition can have a first bond with a first tannin molecule in the one or more tannins. The carbon atom in the at least one aldehyde functional group of the multifunctional aldehyde compound in the cured binder composition can also have a second bond with (1) the first tannin molecule, (2) a second tannin molecule in the one or more tannins, or (3) an oxygen atom of the at least one aldehyde functional group. For example, the carbon atom in at least one aldehyde functional group of the multifunctional aldehyde compound can form a first and a second bond with a first tannin molecule in the one or more tannins when the binder composition is at least partially cured. In another example, the carbon atom in at least one aldehyde functional group of the multifunctional aldehyde compound can for a first bond with a first tannin molecule in the one or more tannins and a second bond with a second tannin molecule in the one or more tannins when the binder composition is at least partially cured. In another example, the carbon atom in at least one aldehyde functional group of the multifunctional aldehyde compound can for a first bond with a first tannin molecule in the one or more tannins and a can have or maintain a second bond to the oxygen atom of the at least one aldehyde functional group. Said another way, in the cured binder composition, the carbon atom of at least one aldehyde functional group of the multifunctional aldehyde compound can have a first bond with a first tannin molecule in the one or more tannins and a second bond with the first tannin molecule, a second tannin molecule in the one or more tannins, or the oxygen atom of the at least one aldehyde functional group.

Some illustrative reaction products (A, B, C, D) of glutaraldehyde and a tannin containing a resorcinol unit, e.g., black wattle tannin or quebracho tannin, are shown below in Scheme I. For simplicity, the tannin is represented by its flavonoid unit structure. R, as shown in the product labeled D can be one or more flavonoid units or other functional groups that can connect two flavonoid units of a tannin together.

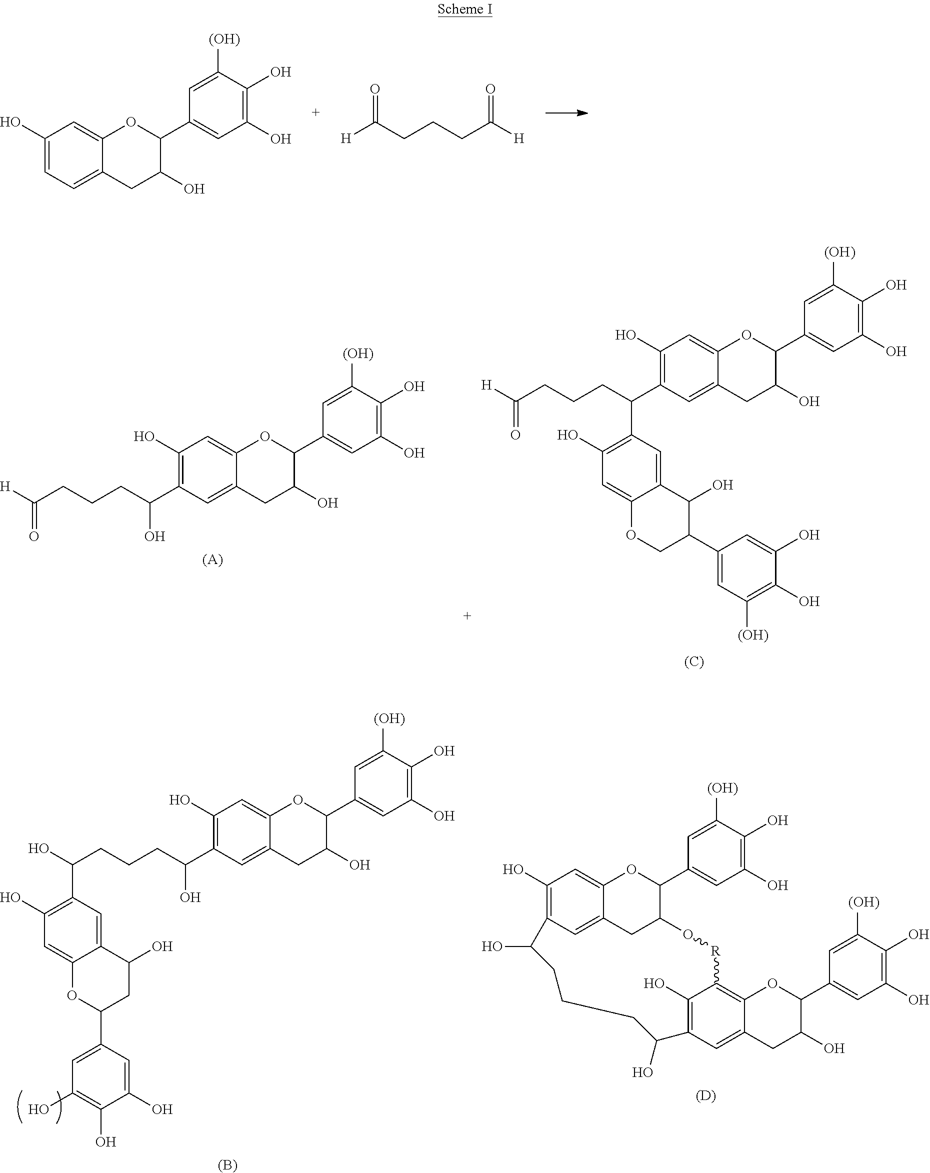

Some illustrative reaction products (A, B, C, D) of glutaraldehyde and a tannin containing a phloroglucinol unit, e.g., pecan tannin or pine tannin, are shown below in Scheme II. For simplicity, the tannin is represented by its flavonoid unit structure. R, as shown in the product labeled D can be one or more flavonoid units or other functional groups that can connect two flavonoid units of a tannin together.

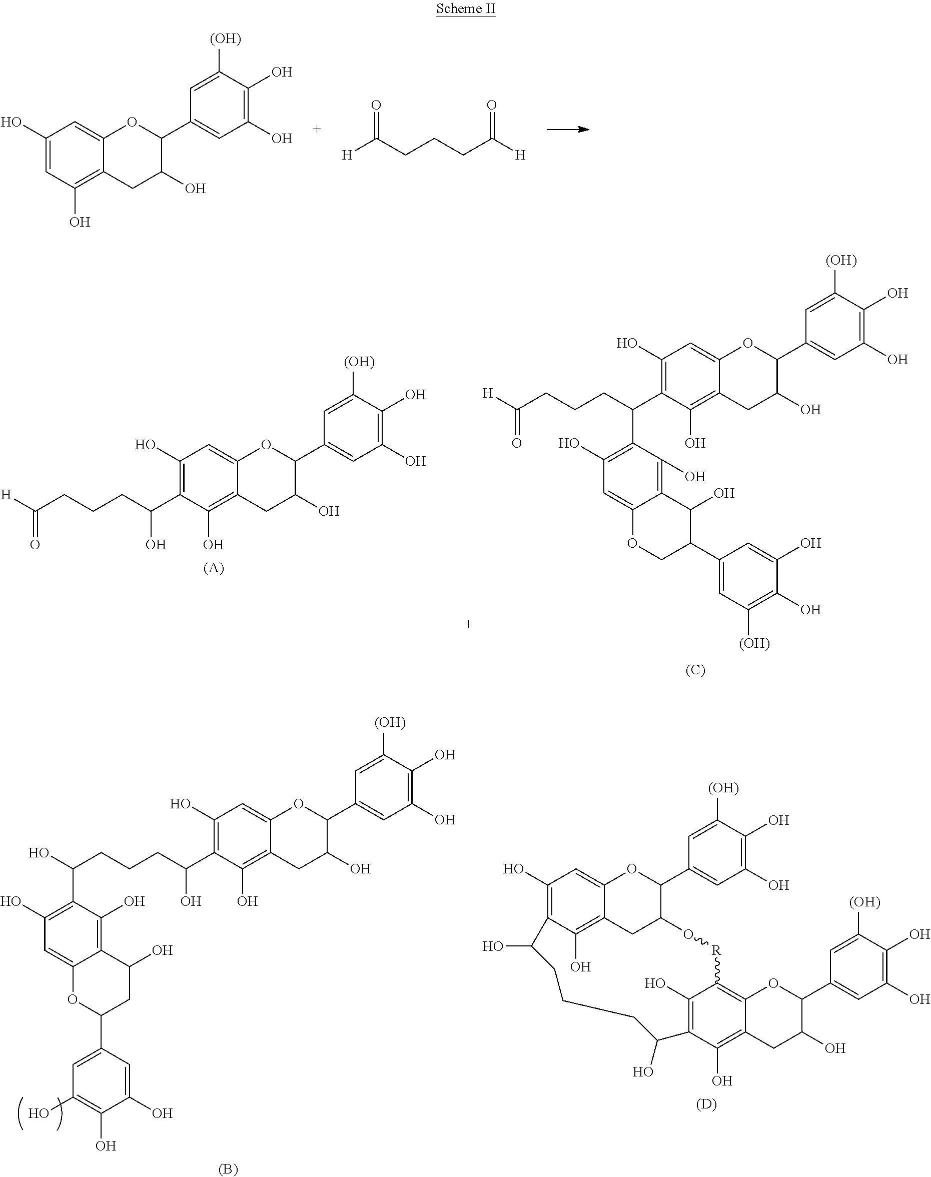

As shown in both Scheme I and II, for products A and B the carbon atom of at least one aldehyde group can form a first bond with a first tannin and a second bond with the oxygen atom of the aldehyde group. Also shown in Schemes I and II, for reaction product C, the carbon atom of at least one aldehyde group can form a first bond with a first tannin and a second bond with a second tannin. For reaction product D shown in Schemes I and II, the carbon atom of at least one aldehyde group can form a first bond with a first tannin and a second bond with the first tannin. Without wishing to be bound by theory, it is believed that the probability of the carbon atom of the at least one aldehyde functional group of the multifunctional aldehyde to form a first bond and second bond with the same tannin molecule increases as the number of flavonoid units increase. Tannins can include multiple flavonoid units, e.g., from 2 to 11, and the greater the number of flavonoid units the greater the likelihood is that the carbon atom of an aldehyde group can form a first and second bond with the same tannin.

The base compound can be or include any compound or combination of compounds capable of increasing the pH of the binder composition that includes the tannin and the multifunctional aldehyde. Suitable bases or alkaline compounds can include, but are not limited to, hydroxides, carbonates, oxides, tertiary amines, amides, any combination thereof, or any mixture thereof. Illustrative hydroxides can include, but are not limited to, sodium hydroxide, potassium hydroxide, lithium hydroxide, cesium hydroxide, barium hydroxide, calcium hydroxide, magnesium hydroxide, aluminum hydroxide, any combination thereof, or any mixture thereof. Illustrative carbonates can include, but are not limited to, sodium carbonate, sodium bicarbonate, potassium carbonate, ammonium carbonate, any combination thereof, or any mixture thereof. Illustrative amines can include trimethylamine, triethylamine, triethanolamine, N,N-diisopropylethylamine (Hunig's base), pyridine, 4-dimethylaminopyridine (DMAP), 1,4-diazabicyclo[2.2.2]octane (DABCO), any combination thereof, or any mixture thereof.

In at least one specific embodiment, the base compound can be free from any amino containing compounds. Illustrative amino containing compounds can include, but are not limited to, ammonia, amines, and amides. As such, in at least one example, the binder composition can be free or essentially free of any amino compounds. As used herein, the term “essentially free of any amino compounds” means the binder composition does not include or contain any intentionally added ammonia, amines, or amides. Said another way, the term “essentially free of any amino compounds” means the binder composition does not contain amino compounds, but may include amino compounds present as an impurity. As such, the term “essentially free of any amino compounds” can refer to the presence of less than 5 wt %, less than 4 wt %, less than 3 wt %, less than 2 wt %, less than 1 wt %, less than 0.5 wt %, less than 0.1 wt %, or less than 0.05 wt % amino compounds, based on the total weight of the binder composition. Additionally, since the carbon atom of the at least one aldehyde functional group of the multifunctional aldehyde compound can bond to one or more tannins or a tannin and an oxygen atom, the carbon atom of the at least one aldehyde functional group of the multifunctional aldehyde compound in the binder composition can be free from any bond to a nitrogen atom. In other words, the binder composition can be free from nitrogen atoms bonded to the carbon atom of the at least one aldehyde functional group of the multifunctional compound.

The binder composition can include a sufficient amount of the base compound to provide a binder composition with a pH from about 4 to about 14. For example, the pH of the binder composition can be from a low of about 4, about 5, about 6, about 7, or about 8 to a high of about 9, about 10, about 11, or about 12. In at least one other embodiment, the binder composition can have a pH of about 7 or more. In another example, the binder composition can have a pH of at least 4, at least 4.5, at least 5, at least 5.5, at least 6, at least 6.5, at least 7, at least 7.5, at least 8, at least 8.5, at least 9, at least 9.5, at least 10, at least 10.5, at least 11, at least 11.5, or at least 12. In another example, the binder composition can have a pH less than 12, less than 11.5, less than 11, less than 10.5, less than 10, less than 9.5, less than 9, less than 8.5, less than 8, less than 7.5, less than 7, less than 6.5, less than 6, less than 5.5, less than 5, or less than 4.5. In another example, the binder composition can have a pH from about 2 to about 5, about 3 to about 6, about 4 to about 7, about 5 to about 8, about 6 to about 9, about 7 to about 10, about 8 to about 11, about 9 to about 12, about 8 to about 12, about 7 to about 11, or about 7 to about 12. The base compound can be an aqueous solution. For example, the base compound can be a 50 wt % aqueous sodium hydroxide solution.

In one or more embodiments, the binder composition can have a pH of less than 2. For example, one or more acid compounds can be combined with the binder composition to provide the binder composition with a pH of about 2 or less. In another example, the pH of the binder composition can be less than 2, less than 1.9, less than 1.8, less than 1.7, less than 1.6, less than 1.5, less than 1.4, less than 1.3, less than 1.2, less than 1.1, less than 1, less than 0.9, less than 0.8, less than 0.7, less than 0.6, or less than 0.5. For example, the pH of the binder composition can be from about 0.3 to about 2, about 0.4 to about 1.9, about 0.5 to about 1.8, about 0.6 to about 1.7, about 0.7 to about 1.6, about 0.8 to about 1.5, about 0.7 to about 1.4, about 0.6 to about 1.3, about 0.5 to about 1.2, or about 0.4 to about 1.1. Suitable acid compounds that can be combined with the binder composition to reduce the pH thereof, can include, but are not limited to, hydrochloric acid, sulfuric acid, nitric acid, hydrobromic acid, hydroiodic acid, perchloric acid, phosphoric acid, methanesulfonic acid, p-toluenesulfonic acid, sulfamic acid, boric acid chelated with diol or polyol, oxalic acid, citric acid, any combination thereof, or any mixture thereof.

The one or more tannins, the one or more multifunctional aldehydes, and the one or more base compounds can be mixed, blended, or otherwise combined with one another to produce the binder composition. The tannin and the multifunctional aldehyde, when combined with one another to produce the binder composition, can crosslink with one another to form an at least partially cured binder composition. Similarly, the tannin and the multifunctional aldehyde, when combined with one another in the presence of the base compound, can crosslink with one another to form the at least partially cured binder composition. For example, the carbon atom in at least one aldehyde functional group of the multifunctional aldehyde compound can bond with the tannin upon at least partial curing of the binder composition.

As discussed in more detail below, the binder composition can be applied to a plurality of substrates, e.g., particles, particulates, fibers, and/or veneer, and at least partially cured to produce a product. The crosslinking reactions between the tannin and the multifunctional aldehyde in the binder composition can occur at room temperature and pressure or at elevated temperature and/or pressure. Applying heat and/or pressure can accelerate the crosslinking or curing of the binder composition. Suitable temperatures for curing the binder compositions can be from a low of about 20° C., about 30° C., or about 40° C. to a high of about 150° C., about 200° C., about 250° C., or about 300° C. The composite material combined with the binder composition, e.g., wood particulates and/or fibers, can be pressed to form a more compact or dense product than would otherwise be produced without the applied pressure. Suitable pressures for curing the binder compositions applied to a composite material can be from a low of about 101 kPa, about 1 MPa, or about 2 MPa to a high of about 5 MPa, about 7 MPa, about 10 MPa, or about 14 MPa.

The tannin and the multifunctional aldehyde can be combined with one another in widely varying amounts with respect to one another to produce the binder compositions discussed and described herein. For example, the binder composition can include the tannin in an amount from a low of about 60 wt %, about 70 wt %, or about 80 wt % to a high of about 85 wt %, about 90 wt %, about 95 w %, or about 99 wt %, based on the combined weight of the tannin and the multifunctional aldehyde. In another example, the binder composition can include the tannin in an amount from about 75 wt % to about 98 wt %, about 80 wt % to about 97 wt %, about 82 wt % to about 95 wt %, about 85 wt % to about 92 wt %, or about 87 wt % to about 90 wt %, based on the combined weight of the tannin and the multifunctional aldehyde. In another example, the binder composition can include the multifunctional aldehyde in an amount from a low of about 1 wt %, about 3 wt %, about 5 wt % or about 10 wt % to a high of about 15 wt %, about 25 wt %, about 35 wt %, or about 40 wt %, based on the combined weight of the tannin and the multifunctional aldehyde. In yet another example, the binder composition can include the multifunctional aldehyde in an amount from about 2 wt % to about 22 wt %, about 4 wt % to about 20 wt %, about 6 wt % to about 18 wt %, about 8 wt % to about 16 wt %, or about 10 wt % to about 14 wt %, based on the combined weight of the tannin and the multifunctional aldehyde. In another example, the binder composition can include about 80 wt % to about 95 wt % of the tannin and about 5 wt % to about 20 wt % of the multifunctional aldehyde, based on the combined weight of the tannin and the multifunctional aldehyde. In still another example, the binder composition can include about 85 wt % to about 90 wt % of the tannin and about 10 wt % to about 15 wt % of the multifunctional aldehyde. In yet another example, the binder composition can include about 86 wt %, about 87 wt %, about 88 wt %, about 89 wt %, or about 90 wt % of the tannin and about 14 wt %, about 13 wt %, about 12 wt %, about 11 wt %, or about 10 wt % of the multifunctional aldehyde, respectively, based on the combined weight of the tannin and the multifunctional aldehyde. In another example, the tannin can be present in the binder composition in an amount of from about 60 wt % to about 99 wt %, or about 80 wt % to about 95 wt %, or about 85 wt % to about 91 wt %, based on the combined weight of the tannin and the multifunctional aldehyde. The amount of the base compound in the binder composition can be sufficient to adjust the pH of the combined tannin and multifunctional aldehyde, which as discussed above can be from about 4 to about 14. In another example, the amount of the acid compound in the binder composition can be sufficient to adjust the pH of the combined tannin and multifunctional aldehyde, which as discussed above can be about 2 or less.

The tannin, the multifunctional aldehyde, and/or the base compound can be combined with a liquid medium. For example, the tannin, the multifunctional aldehyde, and/or the base compound can be separately combined with a liquid medium and then combined with one another to produce the binder composition. In another example, the tannin, the multifunctional aldehyde, and the base compound can be combined with one another to produce the binder composition and a liquid medium can then be added to the binder composition. Illustrative liquid mediums can include, but are not limited to, water, alcohols, glycols, acetonitrile, dimethyl sulfoxide, N,N-dimethylformamide, N-methylpyrrolidone, any combination thereof, or any mixture thereof. Suitable alcohols can include, but are not limited to, methanol, ethanol, propanol, isopropanol, butanol, any combination thereof, or any mixture thereof. Suitable glycols can include, but are not limited to, ethylene glycol, propylene glycol, or a combination thereof.

The tannin, the multifunctional aldehyde, and/or the base compound combined with a liquid medium can have a total concentration of solids in an amount of from about 1 wt % to about 99 wt %. For example, the tannin combined with a liquid medium can have a concentration of solids of from a low of about 5 wt %, about 10 wt %, about 15 wt %, or about 20 wt % to a high of about 40 wt %, about 50 wt %, about 60 wt %, about 70 wt %, or about 80 wt %, based on the combined weight of the tannin and the liquid medium. Similarly, the multifunctional aldehyde compound combined with a liquid medium can have a concentration of solids of from a low of about 5 wt %, about 10 wt %, about 15 wt %, or about 20 wt % to a high of about 40 wt %, about 50 wt %, about 60 wt %, about 70 wt %, or about 80 wt % based on the combined weight of the multifunctional aldehyde compound and the liquid medium. Similarly, the base compound combined with a liquid medium can also have a concentration of solids from a low of about 5 wt %, about 10 wt %, about 15 wt %, or about 20 wt % to a high of about 40 wt %, about 50 wt %, about 60 wt %, about 70 wt %, or about 80 wt %, based on the combined weight of the base compound and the liquid medium. In at least one example, the tannin, the multifunctional aldehyde, and the base compound can each be combined with water to form aqueous mixtures and those aqueous mixtures can then be combined to produce the binder composition. For example 50% aqueous solutions of the tannin, the multifunctional aldehyde, and the base compound can be combined with one another to produce the binder composition. In another example, any one or more of the tannin, multifunctional aldehyde compound, and base compound can be an aqueous solution having a solids content of from about 1 wt % to about 99 wt %, about 1 wt % to about 95 wt %, about 1 wt % to about 90 wt %, about 1 wt % to about 80 wt %, about 1 wt % to about 70 wt %, about 5 wt % to about 60 wt %, about 10 wt % to about 50 wt %, about 20 wt % to about 60 wt %, or about 30 wt % to about 50 wt %.

As used herein, the solids content of the tannin, the multifunctional aldehyde, and the base compound when combined with a liquid medium, as understood by those skilled in the art, can be measured by determining the weight loss upon heating a small sample, e.g., 1-5 grams of the tannin/liquid medium, the multifunctional aldehyde/liquid medium, or the base compound/liquid medium, to a suitable temperature, e.g., 125° C., and a time sufficient to remove the liquid. By measuring the weight of the sample before and after heating, the percent solids in the sample can be directly calculated or otherwise estimated.

In addition to the tannin, the multifunctional aldehyde, and the base compound, and the optional liquid medium, the binder composition can also include one or more additives. The additives can be combined with the tannin, the multifunctional aldehyde, the base compound, the binder composition already containing the combined tannin, and multifunctional aldehyde, and base compound, any combination thereof, or any mixture thereof. Illustrative additives can include, but are not limited to, waxes or other hydrophobic additives, water, filler material(s), extenders, surfactants, release agents, dyes, fire retardants, formaldehyde scavengers, biocides, any combination thereof, or any mixture thereof. For composite wood products, such as plywood, suitable filler material(s) can include, but are not limited to, ground pecan and/or walnut shells, and suitable extenders can include, for example, wheat flour. If the binder composition includes additional additives, the amount of each additive can be from a low of about 0.01 wt %, about 0.1 wt %, about 1 wt %, or about 5 wt % to a high of 20 wt %, about 30 wt %, about 40 wt %, or about 50 wt %, based on the combined weight of the tannin and the multifunctional aldehyde. For example, if the binder composition includes additional additives, the amount of each additive can be from about 0.01 wt % to about 5 wt %, about 1 wt % to about 10 wt %, about 5 wt % to about 40 wt %, about 0.01 wt % to about 50 wt %, about 2 w % to about 20 wt %, about 15 wt % to about 45 wt %, or about 1 wt % to about 15 wt %, based on the combined weight of the tannin and the multifunctional aldehyde.

As discussed and described above, the multifunctional aldehyde and the tannin can begin to crosslink with one another upon contact. The cross linking reactions occur more rapidly under alkaline or basic conditions. As noted above, the binder composition can have a pH of less than 2 or from about 4 to about 14. Crosslinking causes the mixture of tannin and multifunctional aldehyde to thicken or gel. The rate at which the crosslinking reactions occur can affect what is commonly referred to as the binder composition “pot life” or “shelf life.” As the crosslinking reactions between the tannin and the multifunctional aldehyde progresses the viscosity of the binder composition increases. Depending on the particular use or application for binder composition, the viscosity of the binder composition can increase to a point at which it can no longer be efficiently or effectively applied, e.g., to a wood composite or fiber composite. When the viscosity of the binder composition increase causes the binder composition to be too thick for use the usable pot life of the binder has been exceeded. The viscosity of the binder composition can be from a low of about 100 centipoise (“cP”), about 500 cP, about 1,000 cP, or about 1,500 cP to a high of about 3,000 cP, about 5,000 cP, about 8,500 cP, or about 10,000 cP. Preferably the viscosity of the binder composition is less than about 10,000 cP, less than about 8,000 cP, less than about 6,500 cP, or less than about 5,000 cP. The viscosity of the binder composition can be determined using a Brookfield Viscometer at a temperature of 25° C.

A long pot life for the binder compositions can be beneficial; however, a pot life on the order of seconds or only a few minutes can be more than acceptable. For example, the binder compositions discussed and described above and elsewhere herein can have pot life of about 30 seconds, about 45 seconds, about 1 minute, about 2 minutes, about 3 minutes, about 4 minutes, about 5 minutes, about 7 minutes, about 10 minutes, about 15 minutes, about 20 minutes, about 30 minutes, or more. The pot life of the binder composition can be extended if desired. Extending the pot life of the binder composition can allow for process upsets that can potentially be encountered during the production of products such as composite wood products and/or composite fiber products. In another example, extending the pot life of the binder composition can allow for off-site production of the binder composition. In other words, if the pot life of the binder composition is sufficiently long, the binder composition can be produced at one facility and transported to another facility that produces one or more products that use the binder composition, e.g., composite wood products and/or composite fiber products.

One way to reduce or prevent the crosslinking reactions between the tannins and multifunctional aldehydes in the binder composition can be to reduce the temperature of the binder composition. For example, the temperature of the binder composition can be reduced to about 20° C. or less, about 15° C. or less, about 10° C. or less, about 5° C. or less, or about 0° C. or less.

Another way to reduce or prevent the crosslinking reactions between the tannins and the multifunctional aldehydes in the binder compositions can include encapsulation of one, two or all three of the tannin, the multifunctional aldehyde, and, if present, the base compound(s). For example, the multifunctional aldehyde can be contained within a capsule or other enclosed shell or container to inhibit or prevent direct contact when combined with the tannins. In another example, the base compound can be contained within a plurality of capsules or other enclosed shells or containers, which can permit the pH of the tannin and multifunctional aldehyde that are in contact with one another to be below about 7 or below about 6. As discussed above, the crosslinking reactions can be slowed, prevented, reduced, or otherwise inhibited when the pH of the tannin and multifunctional aldehyde is less than 7, e.g., a pH of about 2 to about 6.

The capsules can break, burst, or fracture, or otherwise permit the compound(s) contained therein to escape at a desired time or after a desired time. For example, pressure and/or heat applied to wood composite and/or composite fiber to which the binder composition has been applied can cause the capsules to fracture, releasing the compound(s) contained within the capsules and allowing the crosslinking reactions between the multifunctional aldehyde and tannin to occur.

The capsules, if used to encapsulate the tannin, multifunctional aldehyde, and/or base compound can be micro-capsules. Micro-capsules can have an average cross-sectional size of from about 0.25 μm to about 1,000 μm. For example, the micro-capsules can have an average cross-sectional size of from a low of about 1 μm, about 5 μm, or about 10 μm to a high of about 100 μm, about 200 μm, about 400 μm, or about 600 μm. The capsules, if used to encapsulate the tannin, multifunctional aldehyde, and/or base compound, can be macro-capsules. Macro-capsules can have an average cross-sectional size of from about 1,000 μm to about 10,000 μm. For example, the macro-capsules can have an average cross-sectional size of from a low of about 1,000 μm, about 1,500 μm, or about 2,000 μm to a high of about 5,000 μm, about 7,000 μm, or about 9,000 μm. Techniques for the encapsulation of various compounds are discussed and described in U.S. Pat. Nos. 4,536,524; 5,435,376; 5,532,293; 5,709,340; 5,911,923; 5,919,407; 5,919,557; 6,004,417; 6,084,010; 6,592,990; 6,703,127; 6,835,334; 7,286,279; 7,300,530; 7,309,500; 7,323,039; 7,344,705; 7,376,344; 7,550,200.

Preparation of the capsules can include, but is not limited to, interfacial polymerization, phase separation processes, or coacervation processes. Encapsulation methods can also include reaction in an aqueous medium conducted in the presence of negatively-charged, carboxyl-substituted, linear aliphatic hydrocarbon polyelectrolyte material dissolved in the aqueous medium, or reaction in the presence of gum arabic, or reaction in the presence of an anionic polyelectrolyte and an ammonium salt of an acid.

Numerous patents discuss and describe the various techniques that can be used to encapsulate various compounds using various encapsulation materials. For example, U.S. Pat. No. 7,323,039 discloses emulsion methods for preparing core/shell microspheres using an in-water drying method, after which the microspheres are recovered from the emulsion by centrifuging, filtering, or screening. U.S. Pat. No. 7,286,279 discloses microencapsulation processes and compositions prepared in a solution comprising a polymer precursor such as a monomer, chain extender, or oligomer; emulsifying the precursor into a fluorinated solvent; and forming microparticles by hardening the emulsion by polymerization/crosslinking the precursor, including interfacial and/or in-situ polymerization/crosslinking. U.S. Pat. No. 7,376,344 discloses heat sensitive encapsulation. U.S. Pat. No. 7,344,705 discloses preparation of low density microspheres using a heat expansion process, where the microspheres include biocompatible synthetic polymers or copolymers. U.S. Pat. Nos. 7,309,500 and 7,368,130 disclose methods for forming micro-particles, where droplets of chitosan, gelatin, hydrophilic polymers such as polyvinyl alcohol, proteins, peptides, or other materials can be charged in an immiscible solvent to prevent them from coalescing before hardening, optionally treating the gelated micro-particles with a crosslinking agent to modify their mechanical properties. U.S. Pat. No. 7,374,782 discloses the production of microspheres of a macromolecule such as protein mixed with a water-soluble polymer under conditions which permit the water-soluble polymer to remove water from the protein in contact with a hydrophobic surface. U.S. Pat. No. 7,297,404 discloses coacervative microencapsulation, which is followed by phase separation and cross-linking. U.S. Pat. No. 7,375,070 discloses microencapsulated particles with outer walls including water-soluble polymers or polymer mixtures as well as enzymes. U.S. Pat. No. 7,294,678 discloses a polynitrile oxide or polynitrile oxide dispersion microencapsulated within a barrier material coating prior to compounding it into a rubber mixture to prevent premature reaction with rubber particles. U.S. Pat. No. 7,368,613 discloses microencapsulation using capsule materials made of wax-like plastics materials such as polyvinyl alcohol, polyurethane-like substances, or soft gelatin. U.S. Pat. Nos. 4,889,877; 4,936,916; and 5,741,592 are also related to microencapsulation.

Suitable capsule or shell materials can be or include any one or more of a number of different materials. For example, the capsule or shell material can include natural polymers, synthetic polymers, synthetic elastomers, and the like. Illustrative natural polymers can include, but are not limited to, carboxymethylcellulose, zein, cellulose acetate phthalate, nitrocellulose, ethylcellulose, propylhydroxycellulose, gelatin, shellac, gum Arabic, succinylated gelatin, starch, paraffin waxes, bark, proteins, methylcellulose, kraft lignin, arabinogalactan, natural rubber, any combination thereof, or any mixture thereof. Illustrative synthetic polymers can include, but are not limited to, polyvinyl alcohol, polyvinyidene chloride, polyethylene, polyvinyl chloride, polypropylene, polyacrylate, polystyrene, polyacrylonitrile, polyacrylamide, chlorinated polyethylene, polyether, acetal copolymer, polyester, polyurethane, polyamide, polyvinylpyrrolidone, polyurea, poly(p-xylylene), epoxy, polymethyl methacrylate, ethylene-vinyl, polyhydroxyethyl, acetate copolymer, methacrylate, polyvinyl acetate, any combination thereof, or any mixture thereof. Illustrative synthetic elastomers can include, but are not limited to, polybutadiene, acrylonitrile, polyisoprene, nitrile, neoprene, butyl rubber, chloroprene, polysiloxane, styrene-butadiene rubber, hydrin rubber, silicone rubber, ethylene-propylene-diene terpolymers, any combination thereof, or any mixture thereof.

Another way to extend the pot life of the binder compositions can be to block the multifunctional aldehyde with one or more blocking components or blocking agents. Blocking the multifunctional aldehydes can reduce or inhibit the crosslinking reactions between the tannin and the multifunctional aldehydes. As such, blocking the multifunctional aldehyde can be used to form a stable binder composition that does not crosslink to a substantial degree prior to curing of the binder composition. In other words, by blocking the multifunctional aldehyde, the reactivity between the tannin and the multifunctional aldehyde can be inhibited or slowed, thus providing control of when the crosslinking reactions occur. For example, the crosslinking reactions can be delayed until the binder composition has been applied to a plurality of particles, e.g., wood particles and/or fibers, and the blocking component can be deactivated, e.g., removed, by heat and/or pressure, for example, which can then cause the tannin and multifunctional aldehyde to react.

In one or more embodiments, the multifunctional aldehyde can be blocked. For example, the multifunctional aldehyde can be reacted with a blocking component to produce a blocked multifunctional aldehyde. Suitable blocking components can include, but are not limited to, urea, one or more substituted ureas (e.g., dimethyl urea), one or more cyclic ureas (e.g., ethylene urea, substituted ethylene ureas such as 4,5-dihydroxyethylene urea, propylene urea, and substituted propylene ureas such as 4-hydroxy-5-methylpropylene urea), one or more carbamates (e.g., isopropyl or methyl carbamate), one or more glycols (e.g., ethylene glycol and dipropylene glycol), one or more polyols (e.g., containing at least three hydroxy groups such as glycerin), any combination thereof, or any mixture thereof.

The reaction of the multifunctional aldehydes and the blocking component, e.g., urea or cyclic urea, can occur at a temperature of from about 25° C. to about 100° C. or about 40° C. to about 80° C. In general the pH of the reactants and the resultant blocked multifunctional aldehydes can have a pH of from a low of about 2.5, about 3, about 3.5, or about 4 to a high of about 7, about 8, about 9, or about 10. Additional process conditions for preparing blocked multifunctional aldehydes and suitable blocking components can be as discussed and described in U.S. Pat. Nos. 4,695,606; 4,625,029, 4,656,296; and 7,807,749.

It should be noted that encapsulation, cooling, and/or the addition of blocking components are not necessary to produce the binder compositions discussed and described herein. Encapsulation, cooling, and/or the blocking components can be used, if desired, to extend the pot life of the binder compositions discussed and described herein.

The binder compositions can be used to make, produce, or otherwise prepare a variety of products. The binder composition can be applied to a plurality of substrates, which can be formed into a desired shape before or after application of the binder composition, and then the binder composition can be at least partially cured to produce a product.

The substrates can include, but are not limited to, organic based substrates, inorganic based substrates, or a combination thereof. Suitable organic based substrates can include but are not limited to, lignocellulose material (substrates that include both cellulose and lignin), straw, hemp, sisal, cotton stalk, wheat, bamboo, sabai grass, rice straw, banana leaves, paper mulberry (i.e., bast fiber), abaca leaves, pineapple leaves, esparto grass leaves, fibers from the genus Hesperaloe in the family Agavaceae jute, salt water reeds, palm fronds, flax, ground nut shells, hardwoods, softwoods, recycled fiberboards such as high density fiberboard, medium density fiberboard, low density fiberboard, oriented strand board, particleboard, animal fibers (e.g., wool, hair), recycled paper products (e.g., newspapers, cardboard, cereal boxes, and magazines), any combination thereof, or any mixture thereof. For example, organic based substrates can be or include wood, for example hardwoods, softwoods, or a combination thereof. Illustrative types of wood can include, but are not limited to, Alder, Ash, Aspen, Basswood, Beech, Birch, Cedar, Chemy, Cottonwood, Cypress, Elm, Fir, Gum, Hackberry, Hickory, Maple, Oak, Pecan, Pine, Poplar, Redwood, Sassafras, Spruce, Sweetgum, Sycamore, Walnut, and Willow. Inorganic based fibers can include, but are not limited to plastic fibers (e.g., polypropylene fibers, polyethylene fibers, polyvinyl chloride fibers, polyester fibers, polyamide fibers, polyacrylonitrile fibers), glass fibers, glass wool, mineral fibers, mineral wool, synthetic inorganic fibers (e.g., aramid fibers, carbon fibers), ceramic fibers, and any combination thereof. Organic and inorganic based fibers can be combined to provide the fibers.

The starting material, from which the substrates can be derived from, can be reduced to the appropriate size by various processes such as hogging, grinding, hammer milling, tearing, shredding, and/or flaking. Suitable forms of the substrates can include, but are not limited to, chips, fibers, shavings, sawdust or dust, or the like. The substrates can have a length of from a low of about 0.05 mm, about 0.1 mm, about 0.2 mm to a high of about 1 mm, about 5 mm, about 10 mm, about 20 mm, about 30 mm, about 40 mm, about 50 mm, or about 100 mm.

Illustrative composite wood products or articles produced using the binder compositions can include, but are not limited to, particleboard, fiberboard such as medium density fiberboard (“MDF”) and/or high density fiberboard (“HDF”), plywood such as hardwood plywood and/or softwood plywood, oriented strand board (“OSB”), laminated veneer lumber (“LVL”), laminated veneer boards (“LVB”), and the like.

The production of wood-containing and other substrate-containing products can include contacting a plurality of substrates with the binder composition to form or produce a mixture. The mixture can also be referred to as a “furnish,” “blended furnish,” “resinated mixture,” or “resinated furnish.” The substrates can be contacted with the binder composition by spraying, coating, mixing, brushing, falling film or curtain coater, dipping, soaking, or the like. After contacting the plurality of substrates with the binder composition, the binder composition can be at least partially cured. At least partially curing the binder composition can include applying heat and/or pressure thereto. The binder composition can also at least partially cure at room temperature and pressure. The substrates contacted with the binder composition can be formed into a desired shape, e.g., a board, a woven mat, or a non-woven mat. The mixture can be formed into a desired shape before, during, and/or after partial curing of the binder composition. Depending on the particular product, the mixture or resinated furnish can be pressed before, during, and/or after the binder composition is at least partially cured. For example, the mixture can be consolidated or otherwise formed into a desired shape, if desired pressed to a particular density and thickness, and heated to at least partially cure the binder composition. In another example, the mixture can be extruded through a die (extrusion process) and heated to at least partially cure the binder composition.

In one or more embodiments, the mixture can be heated in air. In one or more embodiments, the mixture can be heated in an inert atmosphere or substantially an inert atmosphere such as nitrogen. If the mixture is heated in a substantially inert atmosphere the amount of oxygen can be less than about 5 mol %, less than about 3 mol %, less than about 1 mol %, less than about 0.5 mol %, or less than about 0.1 mol % oxygen. Suitable inert gases can include, but are not limited to, nitrogen, argon, or a mixture thereof.

In one or more embodiments, pressure can be applied during production of the composite products. The pressure applied can depend, at least in part, on the particular product. For example, the amount of pressure applied to a particleboard process can be from about 1 MPa to about 5 MPa or from about 2 MPa to about 4 MPa. In another example, the amount of pressure applied to a MDF product can be from about 2 MPa to about 14 MPa or from about 2 MPa to about 7 MPa or from about 3 MPa to about 6 MPa. The temperature the mixture can be heated to produce an at least partially cured product can be from a low of about 100° C., about 125° C., about 150° C., or about 170° C. to a high of about 180° C., about 200° C., about 220° C., about 250° C., or about 300° C. The length of time the pressure can be applied can be from a low of about 30 seconds, about 1 minute, about 3 minutes, about 5 minutes, or about 7 minutes to a high of about 10 minutes, about 15 minutes, about 20 minutes, or about 30 minutes, which can depend, at least in part, on the particular product and/or the particular dimensions, e.g., thickness of the product.

For wood based or wood containing products such as particleboard, fiberboard, plywood, and oriented strand board, the amount of the binder composition applied to the cellulose material can be from a low of about 3 wt %, about 4 wt %, about 5 wt % or about 6 wt % to a high of about 10 wt %, about 12 wt %, about 15 wt %, or about 20 wt %, based on the dry weight of the wood based or wood containing material. For example, a wood composite product can contain from about 5 wt % to about 15 wt %, about 8 wt % to about 14 wt %, about 10 wt % to about 12 wt %, or about 7 wt % to about 10 wt % binder composition, based on the dry weight of the wood based or wood containing material.

Wood based or wood containing products such as particleboard, fiberboard, plywood, and oriented strand board, can have a thickness of from a low of about 1.5 mm, about 5 mm, or about 10 mm to a high of about 30 mm, about 50 mm, or about 100 mm. Wood based or wood containing products can be formed into sheets or boards. The sheets or boards can have a length of about 1.2 m, about 1.8 m, about 2.4 m, about 3 m, or about 3.6 m. The sheets or boards can have a width of about 0.6 m, about 1.2 m, about 1.8 m, about 2.4 m, or about 3 m.

Another class or type of products for which the binder composition can be used to produce or make can include fiber mats and other fiber containing products. Fiber mats can be manufactured in a wet-laid or dry-laid process. In a wet-laid process, chopped bundles of fibers, having suitable length and diameter, can be introduced to an aqueous dispersant medium to produce an aqueous fiber slurry, known in the art as “white water.” The white water can contain about 0.5 wt % fibers. The fibers can have a diameter of from about 0.5 μm to about 30 μm and a length of from about 5 mm to about 50 mm, for example. The fibers can be sized or unsized and wet or dry, as long as the fibers can be suitably dispersed within the aqueous fiber slurry.

The fiber slurry, diluted or undiluted, can be introduced to a mat-forming machine that can include a mat forming screen, e.g., a wire screen or sheet of fabric, which can form a fiber product and can allow excess water to drain therefrom, thereby forming a wet or damp fiber mat. The fibers can be collected on the screen in the form of a wet fiber mat and excess water is removed by gravity and/or by vacuum assist. The removal of excess water via vacuum assist can include one or more vacuums.

The binder composition can be formulated as a liquid and applied onto the dewatered wet fiber mat. Application of the binder composition can be accomplished by any conventional means, such as by soaking the mat in an excess of binder composition solution or suspension, a falling film or curtain coater, spraying, dipping, or the like. Excess binder composition can be removed, for example under vacuum.

The binder composition, after it is applied to the fibers, can be at least partially cured. For example, the fiber product can be heated to effect final drying and full curing. The duration and temperature of heating can affect the rate of processibility and handleability, degree of curing and property development of the treated substrate. The curing temperature can be from about 50° C. to about 300° C., preferably from about 90° C. to about 230° C. and the curing time will usually be somewhere between 1 second to about 15 minutes. On heating, water present in the binder composition evaporates, and the composition undergoes curing.

The binder composition can be blended with other additives or ingredients commonly used in compositions for preparing fiber products and diluted with additional water to a desired concentration which is readily applied onto the fibers, such as by a curtain coater. Illustrative additives can include, but are not limited to, dispersants, biocides, viscosity modifiers, pH adjusters, coupling agents, surfactants, lubricants, defoamers, and the like. For example, the binder composition or adhesive can be added to an aqueous solution (“white water”) of polyacrylamide (“PAA”), amine oxide (“AO”), or hydroxyethylcellulose (“HEC”). In another example, a coupling agent (e.g., a silane coupling agent, such as an organo silicon oil) can also be added to the solution. In another example, a coupling agent can be incorporated in a coating on the fibers.

The fiber product can be formed as a relatively thin product having a thickness of about 0.1 mm to about 6 mm. In another example, a relatively thick fiber product having a thickness of about 10 cm to about 50 cm, or about 15 cm to about 30 cm, or about 20 cm to about 30 cm can be formed. In another example, the fiber product can have a thickness from a low of about 0.1 mm, about 1 mm, about 1.5 mm, or about 2 mm to a high of about 5 mm, about 1 cm, about 5 cm, about 10 cm, about 20 cm, about 30 cm, about 40 cm, or about 50 cm. Depending on formation conditions, the density of the product can also be varied from a relatively fluffy low density product to a higher density of about 6 to about 10 pounds per cubic foot or higher. The fiber mat product can have a basis weight of from a low of about 0.1 pound, about 0.5 pounds, or about 0.8 pounds to a high of about 3 pounds, about 4 pounds, or about 5 pounds per 100 square feet. For example, the fiber mat product can have a basis weight of from about 0.6 pounds per 100 square feet to about 2.8 pounds per 100 square feet, about 1 pound per 100 square feet to about 2.5 pounds per 100 square feet, or about 1.5 pounds per 100 square feet to about 2.2 pounds per 100 square feet. In at least one specific embodiment, the fiber mat product can have a basis weight of about 1.2 pounds per 100 square feet, about 1.8 pounds per 100 square feet, or about 2.4 pounds per 100 square feet.

The fibers can represent the principal material of the non-woven fiber products, such as a fiber mat product. For example, 60 wt % to about 95 wt % of the fiber product, based on the combined amount of binder composition and fibers can be composed of the fibers. The binder composition can be applied in an amount such that the cured binder composition constitutes from about 1 wt % to about 40 wt % of the finished glass fiber product. The binder composition can be applied in an amount such that the cured resin constitutes a low of from about 1 wt %, about 5 wt %, or about 10 wt % to a high of about 15 wt %, about 20 wt %, or about 25 wt %, based on the combined weight of the resin and the fibers.

As used herein, the terms “fiber,” “fibrous,” “fiberglass,” “fiber glass,” “glass fibers,” and the like are refer to materials or substrates that have an elongated morphology exhibiting an aspect ratio (length to thickness) of greater than 100, generally greater than 500, and often greater than 1,000. Indeed, an aspect ratio of over 10,000 is possible. Suitable fibers can be glass fibers, natural fibers, synthetic fibers, mineral fibers, ceramic fibers, metal fibers, carbon fibers, any combination thereof, or any mixture thereof. Illustrative glass fibers can include, but are not limited to, A-type glass fibers, C-type glass fibers, E-type glass fibers, S-type glass fibers, ECR-type glass fibers, wool glass fibers, and any combination thereof. The term “natural fibers,” as used herein refers to plant fibers extracted from any part of a plant, including, but not limited to, the stem, seeds, leaves, roots, or phloem. Illustrative natural fibers can include, but are not limited to, cotton, jute, bamboo, ramie, bagasse, hemp, coir, linen, kenaf, sisal, flax, henequen, and any combination thereof. Illustrative synthetic fibers can include, but are not limited to, synthetic polymers, such as polyester, polyamide, aramid, and any combination thereof. In at least one specific embodiment, the fibers can be glass fibers that are wet use chopped strand (“WUCS”) glass fibers. Wet use chopped strand glass fibers can be formed by conventional processes known in the art. The WUCS glass fibers can have a moisture content of from a low of about 5%, about 8%, or about 10% to a high of about 20%, about 25%, or about 30%.

Prior to using the fibers to make a fiber product, the fibers can be allowed to age for a period of time. For example, the fibers can be aged for a period of a few hours to several weeks before being used to make a fiber product. For some fiber mat products, e.g., glass fiber products, the fibers can be aged for about 3 to about 30 days. Ageing the fibers includes simply storing the fibers at room temperature for the desired amount of time prior to being used in making a fiber product.

The binder composition discussed and described above or elsewhere herein can be used to produce a variety of fiber products. The fiber products can be used by themselves or incorporated into a variety of other products. For example, fiber products can be used as produced or incorporated into insulation batts or rolls, composite flooring, asphalt roofing shingles, siding, gypsum wall board, roving, microglass-based substrate for printed circuit boards, battery separators, filter stock, tape stock, carpet backing, and as reinforcement scrim in cementitious and non-cementitious coatings for masonry.

Any one or more of the binder compositions discussed and described above can be combined with one or more additional or second binder or adhesive compositions to produce a binder or adhesive system (multi-binder system). The one or more second binder compositions or adhesives can be different from the one or more binder compositions discussed and described above.

Illustrative additional or second binder or adhesive compositions can include, but are not limited to, aldehyde containing or aldehyde based resin; a mixture of Maillard reaction products; a reaction product of Maillard reactants; a copolymer of one or more vinyl aromatic derived units and at least one of maleic anhydride and maleic acid; a polyamideoamine-epichlorhydrin polymer; a mixture and/or reaction product of a polyamidoamine and ammonia-epichlorhydrin adduct binder; a mixture and/or reaction product of a polyamidoamine-epichlorhydrin polymer and at least one of a soy protein, a wheat protein, a pea protein, a corn protein, and a guar protein; an adduct or polymer of styrene, at least one of maleic anhydride and maleic acid, and at least one of an acrylic acid and an acrylate; a polyacrylic acid based binder; polyvinyl acetate; polymeric methylene diisocyanate (“pMDI”); starch; protein; lignin; or any combination thereof. Illustrative aldehyde containing or aldehyde based resins can include, but are not limited to, urea-aldehyde polymers, melamine-aldehyde polymers, phenol-aldehyde polymers, resorcinol-aldehyde resins, any combination thereof, or any mixture thereof. Combinations of aldehyde based resins can include, for example, melamine-urea-aldehyde, phenol-urea-aldehyde, and phenol-melamine-aldehyde.

Illustrative aldehyde based resins can include, but are not limited to, one or more amino-aldehyde resins, phenol-aldehyde resins, dihydroxybenzene or “resorcinol”-aldehyde resins, any combination thereof, or any mixture thereof. The amino component of the amino-aldehyde resins can be or include, but is not limited to, urea, melamine, or a combination thereof. The aldehyde based resins can include, but are not limited to, urea-formaldehyde (“UF”) resins, phenol-formaldehyde (“PF”) resins, melamine-formaldehyde (“MF”) resins, resorcinol-formaldehyde (“RF”) resins, styrene-acrylic acid; acrylic acid maleic acid copolymer, any combination thereof, or any mixture thereof. Combinations of amino-aldehyde resins can include, for example, melamine-urea-formaldehyde (“MUF”), phenol-urea-formaldehyde (“PUF”) resins, phenol-melamine-formaldehyde (“PMF”) resins, phenol-resorcinol-formaldehyde (“PRF”) resins, and the like.

Suitable aldehyde compounds for making the amino-aldehyde resins, phenol-aldehyde resins, and/or dihydroxybenzene or “resorcinol”-aldehyde resins can include, but are not limited to, unsubstituted aldehyde compounds and/or substituted aldehyde compounds. For example, suitable aldehyde compounds can be represented by the formula RCHO, wherein R is hydrogen or a hydrocarbon radical. Illustrative hydrocarbon radicals can include from 1 to about 8 carbon atoms. In another example, suitable aldehyde compounds can also include the so-called masked aldehydes or aldehyde equivalents, such as acetals or hemiacetals. Illustrative aldehyde compounds can include, but are not limited to, formaldehyde, paraformaldehyde, acetaldehyde, propionaldehyde, butyraldehyde, furfuraldehyde, benzaldehyde, any combination thereof, or any mixture thereof. One or more other aldehydes, such as glyoxal can be used in place of or in combination with formaldehyde and/or other aldehydes. In at least one example, the aldehyde compound can include formaldehyde, UFC, or a combination thereof.

Illustrative aldehyde compounds can also include the so-called masked aldehydes or aldehyde equivalents, such as acetals or hemiacetals. Suitable aldehydes can be represented by the general formula R′CHO, where R′ is a hydrogen or a hydrocarbon radical generally having 1-8 carbon atoms. Specific examples of suitable aldehyde compounds can include, but are not limited to, formaldehyde, acetaldehyde, propionaldehyde, butyraldehyde, furfuraldehyde, benzaldehyde, any combination thereof, or any mixture thereof. As used herein, the term “formaldehyde” can refer to formaldehyde, formaldehyde derivatives, other aldehydes, or combinations thereof. Preferably, the aldehyde component is formaldehyde. One or more difunctional aldehydes can also be used to produce the novolac resin, and could advantageously be used to introduce cross-links ultimately into the at least partially cured binder composition.

The aldehyde can be used in many forms such as solid, liquid, and/or gas. Considering formaldehyde in particular, the formaldehyde can be or include paraform (solid, polymerized formaldehyde), formalin solutions (aqueous solutions of formaldehyde, sometimes with methanol, in 37 percent, 44 percent, or 50 percent formaldehyde concentrations), Urea-Formaldehyde Concentrate (“UFC”), and/or formaldehyde gas in lieu of or in addition to other forms of formaldehyde can also be used. In another example, the aldehyde can be or include a pre-reacted urea-formaldehyde mixture having a urea to formaldehyde weight ratio of about 1:2 to about 1:3.

Suitable urea-formaldehyde resins can be prepared from urea and formaldehyde monomers or from urea-formaldehyde precondensates in manners well known to those skilled in the art. Similarly, melamine-formaldehyde, phenol-formaldehyde, and resorcinol-formaldehyde polymers can be prepared from melamine, phenol, and resorcinol monomers, respectively, and formaldehyde monomers or from melamine-formaldehyde, phenol-formaldehyde, and resorcinol-formaldehyde precondensates. Urea, phenol, melamine, resorcinol, and formaldehyde reactants are commercially available in many forms and any form that can react with the other reactants and does not introduce extraneous moieties deleterious to the desired reaction and reaction product can be used in the preparation of the second copolymer. One suitable class of urea-formaldehyde polymers can be as discussed and described in U.S. Pat. No. 5,362,842.

The urea, if present in the second binder, can be provided in a variety of forms. For example, the urea can be solid urea, such as prill, and/or urea solutions, e.g., aqueous solutions, which are commonly available. Further, urea may be combined with another moiety, e.g., formaldehyde and urea-formaldehyde adducts, often in aqueous solution. Any form of urea or urea in combination with formaldehyde can be used to make a urea-formaldehyde polymer. Both urea prill and combined urea-formaldehyde products are preferred, such as UFC. These types of products can be as discussed and described in U.S. Pat. Nos. 5,362,842 and 5,389,716, for example.

Many suitable urea-formaldehyde polymers are commercially available. Urea-formaldehyde polymers such as the types sold by Georgia-Pacific Chemicals LLC. (e.g., GP®-2928 and GP®-2980) for glass fiber mat applications, those sold by Hexion Specialty Chemicals, and by Arclin Company can be used. Suitable phenol-formaldehyde resins and melamine-formaldehyde resins can include those sold by Georgia Pacific Resins, Inc. (e.g., GP®-2894 and GP®-4878, respectively). These polymers are prepared in accordance with well known methods and contain reactive methylol groups which upon curing form methylene or ether linkages. Such methylol-containing adducts may include N,N′-dimethylol, dihydroxymethylolethylene; N,N′ bis(methoxymethyl), N,N′-dimethylolpropylene; 5,5-dimethyl-N,N′ dimethylolethylene; N,N′-dimethylolethylene; and the like.

Urea-formaldehyde resins can include from about 45% to about 70%, and preferably, from about 55% to about 65% solids, generally have a viscosity of about 50 cP to about 600 cP, preferably about 150 to about 400 cP, normally exhibit a pH of about 7 to about 9, preferably about 7.5 to about 8.5, and often have a free formaldehyde level of not more than about 3.0%, and a water dilutability of about 1:1 to about 100:1, preferably about 5:1 and above.

The phenol can include phenol and/or a variety of substituted phenolic compounds, unsubstituted phenolic compounds, or any combination of substituted and/or unsubstituted phenolic compounds. For example, the phenol component can be phenol itself (i.e., mono-hydroxy benzene). Examples of substituted phenols can include, but are not limited to, alkyl-substituted phenols such as the cresols and xylenols; cycloalkyl-substituted phenols such as cyclohexyl phenol; alkenyl-substituted phenols; aryl-substituted phenols such as p-phenyl phenol; alkoxy-substituted phenols such as 3,5-dimethyoxyphenol; aryloxy phenols such as p-phenoxy phenol; and halogen-substituted phenols such as p-chlorophenol. Dihydric phenols such as catechol, resorcinol, hydroquinone, bis-phenol A and bis-phenol F also can also be used. Specific examples of suitable phenolic compounds (phenol components) for replacing a portion or all of the phenol used in preparing a novolac resin can include, but are not limited to, bis-phenol A, bis-phenol F, o-cresol, m-cresol, p-cresol, 3,5-5 xylenol, 3,4-xylenol, 3,4,5-trimethylphenol, 3-ethyl phenol, 3,5-diethyl phenol, p-butyl phenol, 3,5-dibutyl phenol, p-amyl phenol, p-cyclohexyl phenol, p-octyl phenol, 3,5 dicyclohexyl phenol, p-phenyl phenol, p-phenol, 3,5-dimethoxy phenol, 3,4,5 trimethoxy phenol, p-ethoxy phenol, p-butoxy phenol, 3-methyl-4-methoxy phenol, p-phenoxy phenol, naphthol, anthranol and substituted derivatives thereof. Preferably, about 80 wt % or more, about 90 wt % or more, or about 95 wt % or more of the phenol component includes phenol (monohydroxybenzene). Suitable phenol-formaldehyde resins can include resole resins and/or novolac resins.

Melamine, if present in the second binder, can be provided in a variety of forms. For example, solid melamine, such as prill and/or melamine solutions can be used. Although melamine is specifically referred to, the melamine can be totally or partially replaced with other aminotriazine compounds. Other suitable aminotriazine compounds can include, but are not limited to, substituted melamines, cycloaliphatic guanamines, or combinations thereof. Substituted melamines include the alkyl melamines and aryl melamines that can be mono-, di-, or tri-substituted. In the alkyl substituted melamines, each alkyl group can contain 1-6 carbon atoms and, preferably 1-4 carbon atoms. Illustrative examples of the alkyl-substituted melamines can include, but are not limited to, monomethyl melamine, dimethyl melamine, trimethyl melamine, monoethyl melamine, and 1-methyl-3-propyl-5-butyl melamine. In the aryl-substituted melamines, each aryl group can contain 1-2 phenyl radicals and, preferably, one phenyl radical. Illustrative examples of aryl-substituted melamines can include, but are not limited to, monophenyl melamine and diphenyl melamine. Any of the cycloaliphatic guanamines can also be used. Suitable cycloaliphatic guanamines can include those having 15 or less carbon atoms. Illustrative cycloaliphatic guanamines can include, but are not limited to, tetrahydrobenzoguanamine, hexahydrobenzoguanamine, 3-methyl-tetrahydrobenzoguanamine, 3-methylhexahydrobenzoguanamine, 3,4-dimethyl-1,2,5,6-tetrahydrobenzoguanamine, and 3,4-dimethylhexahydrobenzoguanamine and mixtures thereof. Mixtures of aminotriazine compounds can include, for example, melamine and an alkyl-substituted melamine, such as dimethyl melamine, or melamine and a cycloaliphatic guanamine, such as tetrahydrobenzoguanamine.

The resorcinol component, if present in the second binder, can be provided in a variety of forms. For example, the resorcinol component can be provided as a white/off-white solid or flake and/or the resorcinol component can be heated and supplied as a liquid. Any form of the resorcinol can be used with any form of the aldehyde component to make the resorcinol-aldehyde copolymer. The resorcinol component can be resorcinol itself (i.e., Benzene-1,3-diol). Suitable resorcinol compounds can also be described as substituted phenols. The solids component of a liquid resorcinol-formaldehyde copolymer can be from about 45 wt % to about 75 wt %. Liquid resorcinol-formaldehyde copolymers can have a Brookfield viscosity at 25° C. that varies widely, e.g., from about 200 cP to about 20,000 cP. Liquid resorcinol copolymers can have a dark amber color.

The mixture of Maillard reactants can include, but is not limited to, a source of a carbohydrate (carbohydrate reactant) and an amine reactant capable of participating in a Maillard reaction with the carbohydrate reactant. In another example, the mixture of Maillard reactants can include a partially pre-reacted mixture of the carbohydrate reactant and the amine reactant. The extent of any pre-reaction can preserve the ability of the mixture of Maillard reactants to be blended with any other components desired to be added into composition such as one or more additives. Suitable Maillard reactants and Maillard reaction products can be as discussed and described in U.S. Patent Application Publication No. 2007/0027283; 2007/0123679; 2007/0123680; 2007/0142596; and 2011/0060095.

The aldehyde based resin(s) and/or the Maillard reactant based binder can be modified by combining with one or more modifiers. The modifier can be or include the copolymer of one or more vinyl aromatic derived units and at least one of maleic anhydride and maleic acid, optionally modified by reaction with one or more base compounds. In another example, the modifier can be or include an adduct of styrene, at least one of maleic anhydride and maleic acid, and at least one of an acrylic acid and an acrylate. In another example, the modifier can be or include the one or more latexes. In another example, the modifier can include two or more of: (1) a copolymer comprising one or more vinyl aromatic derived units and at least one of maleic anhydride and maleic acid; (2) an adduct of styrene, at least one of maleic anhydride and maleic acid, and at least one of an acrylic acid and an acrylate; and (3) one or more latexes. The addition of the one or more modifiers to the aldehyde based binder and/or the Maillard reactant based binder can be as discussed and described in U.S. Patent Application Publication No.: 2011/0060095.

The copolymer of one or more vinyl aromatic derived units and at least one of maleic anhydride and maleic acid can be produced using any suitable reactants. Similarly, the copolymer that includes one or more unsaturated carboxylic acids, one or more unsaturated carboxylic anhydrides, or a combination thereof, one or more vinyl aromatic derived units, and one or more base compounds can be produced using any suitable reactants. Similarly, the copolymer modified by reaction with one or more base compounds, where the copolymer includes one or more unsaturated carboxylic acids, one or more unsaturated carboxylic anhydrides, or a combination thereof, one or more vinyl aromatic derived units, can be produced using any suitable reactants. Illustrative vinyl aromatic derived units can include, but are not limited to, styrene, alpha-methylstyrene, vinyl toluene, and combinations thereof. Preferably, the vinyl aromatic derived units are derived from styrene and/or derivatives thereof. More preferably, the vinyl aromatic derived units are derived from styrene to produce a styrene maleic anhydride (acid) or “SMA” copolymer. Suitable SMA copolymers include resins that contain alternating styrenic and maleic anhydride (acid) monomer units, arranged in random, alternating, and/or block forms. The copolymer that includes one or more unsaturated carboxylic acids, one or more unsaturated carboxylic anhydrides, or a combination thereof, one or more vinyl aromatic derived units, and one or more amines can be as discussed and described in U.S. Patent Application Publication No.: 2011/0165398 and U.S. patent application having Ser. No. 13/228,917.

Polyamide-epichlorhydrin polymers can be made by the reaction of epichlorohydrin and a polyamide under basic conditions (i.e., a pH between about 7 to about 11). The resulting polymer can then be contacted with an acid to stabilize the product. See, e.g., U.S. Pat. Nos. 3,311,594 and 3,442,754. Unreacted epichlorohydrin in the product can be hydrolyzed by the acid to 1,3-dichloro-2-propanol (1,3-DCP), 3-chloro-1,2-propanediol (CPD), and 2,3-dichloro-1-propanol (2,3-DCP). The 1,3-DCP product is the predominant hydrolysis product with CPD being formed in levels of about 10% of the 1,3-DCP and 2,3-DCP being formed in levels of about 1% of the 1,3-DCP. Although the final product can include several other types of organic chlorines (as measured by the difference between inorganic chloride and total chlorine concentrations), the 1,3-DCP and CPD concentrations can be accurately determined by C¹³ NMR and GC-MS measuring techniques known in the art. The 2,3-DCP concentrations are, however, generally below the detection limit of C¹³ NMR so 1,3-DCP and CPD are generally used as measurements for the epichlorohydrin hydrolysis products present in the polymer. Of particular utility are the polyamide-epchlorohydrin polymers, an example of which is sold under the trade names Kymene 557LX and Kymene 557H by Hercules, Inc. and AMRES® from Georgia-Pacific Resins, Inc. These polymers and the process for making the polymers are discussed and described in U.S. Pat. Nos. 3,700,623 and 3,772,076. An extensive description of polymeric-epihalohydrin resins is given in Chapter 2: Alkaline—Curing Polymeric Amine—Epichlorohydrin by Espy in Wet Strength Resins and Their Application (L. Chan, Editor, 1994).

Illustrative polyamideoamine-epichlorhydrin polymer; a mixture and/or reaction product of a polyamidoamine and ammonia-epichlorhydrin adduct binder; and/or a mixture and/or reaction product of a polyamidoamine-epichlorhydrin polymer and at least one of a soy protein, a wheat protein, a pea protein, a corn protein, and a guar protein can include those discussed and described in U.S. Pat. Nos. 7,736,559 and 7,781,501; and U.S. Patent Application Publication Nos.: 2006/0142433; 2007/0054144; and 2008/0027159.

The adduct or polymer of styrene, at least one of maleic anhydride and maleic acid, and at least one of an acrylic acid and an acrylate can be produced using any suitable reactants. Any suitable acrylic acid or acrylate can be used such as methyl methacrylate, butyl acrylate, methacrylate, any combination thereof, or any mixture thereof. Preferably, the acrylate is methyl methacrylate (MMA). The adduct can be combined with the aldehyde based polymer, the Maillard reactants, or a combination thereof. In another example, the components of the adduct can be mixed with the aldehyde based polymer, the mixture of Maillard reactants, or a combination thereof.

The adduct can be prepared by dissolving the components of the adduct in a suitable solution. Illustrative solutions can include, but are not limited to, aqueous solutions of sodium hydroxide, ammonium hydroxide, potassium hydroxide, and combinations thereof. The solution can be heated to a temperature of about 70° C. to about 90° C. The solution can be held at the elevated temperature until the components are all at least partially in solution. The solution can then be added to the phenol-aldehyde resin, the mixture of Maillard reactants, or the combination of the phenol-aldehyde resin and the mixture of Maillard reactants.

The adduct can be prepared by combining styrene, at least one of maleic anhydride and maleic acid, and at least one of an acrylic acid and an acrylate to form a terpolymer. The amount of styrene in the adduct can be from a low of about 50 wt %, about 55 wt %, or about 60 wt % to a high of about 75 wt %, about 80 wt %, or about 85 wt %, based on the total weight of the adduct. The amount of the maleic anhydride and/or maleic acid in the adduct can be from a low of about 15 wt %, about 20 wt %, or about 25 wt % to a high of about 40 wt %, about 45 wt %, or about 50 wt %, based on the total weigh of the adduct. The amount of the acrylic acid and/or the acrylate in the adduct can be from a low of about 1 wt %, about 3 wt % or about 5 wt % to a high of about 10 wt %, about 15 wt %, or about 20 wt %, based on the total weight of the adduct.

In another example, the acrylic acid or acrylate can be combined with the copolymer of one or more vinyl aromatic derived units and at least one of maleic anhydride and maleic acid to provide the modifier. For example, combining the acrylic acid or acrylate with SMA can form a styrene maleic anhydride methyl-methacrylate terpolymer. In another example, the modifier can also include a physical mixture of styrene acrylic acid and/or styrene-acrylate copolymer and a SMA copolymer. The adduct or polymer of styrene, at least one of maleic anhydride and maleic acid, and at least one of an acrylic acid and an acrylate and the physical mixture of styrene acrylic acid and/or styrene-acrylate copolymer and a SMA copolymer can be prepared according to the processes discussed and described in U.S. Pat. No. 6,642,299.

The polyacrylic acid based binder can include an aqueous solution of a polycarboxy polymer, a monomeric trihydric alcohol, a catalyst, and a pH adjuster. The polycarboxy polymer can include an organic polymer or oligomer containing more than one pendant carboxy group. The polycarboxy polymer can be a homopolymer or copolymer prepared from unsaturated carboxylic acids including, but not limited to, acrylic acid, methacrylic acid, crotonic acid, isocrotonic acid, maleic acid, cinnamic acid, 2-methylmaleic acid, itaconic acid, 2-methylitaconic acid, α,β-methyleneglutaric acid, and the like. Other suitable polycarboxy polymers can be prepared from unsaturated anhydrides including, but not limited to, maleic anhydride, itaconic anhydride, acrylic anhydride, methacrylic anhydride, and the like, as well as mixtures thereof.

Illustrative trihydric alcohols can include, but are not limited to, glycerol, trimethylolpropane, trimethylolethane, triethanolamine, 1,2,4-butanetriol, and the like. The one or more trihydric alcohols can be mixed with other polyhydric alcohols. Other polyhydric alcohols can include, but are not limited to, ethylene, glycol, 1,3-propanediol, 1,4-butanediol, 1,6-hexanediol, 2-butene-1, erythritol, pentaerythritol, sorbitol, and the like. The catalyst can include an alkali metal salt of a phosphorous-containing organic acid; particularly alkali metal salts of phosphorous acid, hypophosphorous acid, and polyphosphoric acids. Illustrative catalysts can include, but are not limited to, sodium, sodium phosphite, potassium phosphite, disodium pyrophosphate, tetrasodium pyrophosphate, sodium tripolyphosphate, sodium hexametaphosphate, potassium phosphate, potassium polymetaphosphate, potassium polyphosphate, potassium tripolyphosphate, sodium trimetaphosphate, and sodium tetrametaphosphate, any combination thereof, or any mixture thereof. Illustrative polyacrylic acid based polymers can be as discussed and described in U.S. Pat. No. 7,026,390.

Suitable proteins can be or otherwise include, but are not limited to, corn flour, soy flour, wheat flour, spray dried blood, any combination thereof, or any mixture thereof. The soy flour can be a raw soy protein and/or a soy protein modified as discussed and described in U.S. Pat. No. 6,497,760. Raw soy protein can be in the form of ground whole beans (including the hulls, oil, protein, minerals, etc.), a meal (extracted or partially extracted), a flour (i.e., generally containing less than about 1.5% oil and about 30-35% carbohydrate), or an isolate (i.e., a substantially pure protein flour containing less than about 0.5% oil and less than about 5% carbohydrate). Suitable soy protein can be derived from any source of soy protein such as soybean concentrate or soybean meal. Protein-rich soybean-derived flours, such as soy protein isolate, protein concentrate and ordinary defatted soy flour, which can contain about 20-95% protein, can be used. Of these, ordinary soy flour is the most abundant and cost-effective. The source of soy protein (soy flour) can be essentially free of functional urease. Information on soy protein can be found in, for example, Kirk-Othmer, Encyclopedia of Chemical Technology, Fourth Edition, Volume 22, pp. 591-619 (1997). Modified soy protein can be modified with either of two classes of modifiers. The first class of modifiers can include saturated and unsaturated alkali metal C₈-C₂₂ sulfate and sulfonate salts. Two preferred modifiers in this class are sodium dodecyl sulfate and sodium dodecylbenzene sulfonate. The second class of modifiers includes compounds having the formula R₂NC(═X)NR₂, where each R is individually selected from the group consisting of H and C₁-C₄ saturated and unsaturated groups, and X is selected from the group consisting of O, NH, and S. The C₁-C₄ saturated groups refer to alkyl groups (both straight and branched chain) and the unsaturated groups refer to alkenyl and alkynyl groups (both straight and branched chain). Illustrative modifiers in the second group can include, but are not limited to, urea and guanidine hydrochloride. Other suitable soy proteins and preparation thereof can include, but are not limited to, those discussed and described in U.S. Pat. Nos. 2,507,465; 2,492,510; 2,781,286; 3,285,805; 3,957,703; 4,070,314; 4,244,846; and 4,778,530.

Illustrative polysaccharide starches can include, but are not limited to, maize or corn, waxy maize, high amylose maize, potato, tapioca, wheat starch, any combination thereof, or any mixture thereof. Other starches such as genetically engineered starches can include, high amylose potato and potato amylopectin starches.

Lignin is a polymeric substance that can include substituted aromatics found in plant and vegetable matter associated with cellulose and other plant constituents. Illustrative plant and vegetable matter can include, but is not limited to, straw, hemp, sisal, cotton stalk, wheat, bamboo, sabai grass, rice straw, banana leaves, paper mulberry (i.e., bast fiber), abaca leaves, pineapple leaves, esparto grass leaves, fibers from the genus Hesperaloe in the family Agavaceae jute, salt water reeds, palm fronds, flax, ground nut shells, hardwoods, softwoods, recycled fiberboards such as high density fiberboard, medium density fiberboard, low density fiberboard, oriented strand board, particleboard, any combination thereof, or any mixture thereof. For example, the plant matter can be or include wood, for example hardwoods, softwoods, or a combination thereof. Illustrative types of wood can include, but are not limited to, alder, ash, aspen, basswood, beech, birch, cedar, cherry, cottonwood, cypress, elm, fir, gum, hackberry, hickory, maple, oak, pecan, pine, poplar, redwood, sassafras, spruce, sycamore, walnut, and willow.

The lignin can be extracted or otherwise recovered from the plant and/or vegetable matter using any suitable process or combination of processes. For example, in the pulp and paper industry, lignin-containing materials such as wood, straw, corn stalks, bagasse, and other vegetable and plant tissues are processed to recover the cellulose or pulp. As such, the residual pulping liquors that include the lignin as a by-product can be a source of lignin. There can be variation in the chemical structure of lignin. The variation in the chemical structure of lignin can depend, at least in part, on the particular plant from which the lignin is recovered from, location the plant was grown, and/or on the particular method used in recovery or isolation of the lignin from the plant and/or vegetable matter. Lignin can include active groups, such as active hydrogen(s) and/or phenolic hydroxyl group(s) through which crosslinking or bridging can be effected.

Since the lignin separated from the plant may be chemically altered somewhat from that found in the plant, the term “lignin,” can also refer to lignin products obtained upon separation from the cellulose or recovered from the plant matter. For example, in a sulfite pulping process, the lignocellulose material can be digested with a bisulfite or sulfite resulting in the at least partial sulfonation of the lignin. As such, the lignin can optionally be subjected to further cleavage or modifications such as alkaline treatment or reaction with other constituents to decrease the sulfonate sulfur content or increase the active groups. For example, the lignin can be processed such that it has a phenolic hydroxyl content of from about 1.5 wt % to about 5 wt % and less than about 3 wt % sulfonate sulfur. In other methods of recovery or separation of lignin from plant tissue, the lignin may not be sulfonated, but could be chemically altered somewhat in some other manner. For example, in residual pulping liquors obtained in sulfate or other alkaline pulping processes, the lignin can be present as an alkali metal salt dissolved in the alkaline aqueous liquor and can generally include a sufficient phenolic hydroxyl content to require no further modification. However, the alkali or kraft lignin can be further reacted with other constituents to further increase the active groups. “Hydrolysis lignin” that can be recovered from the hydrolysis of lignocellulose materials in the manufacture of sugar can also be altered somewhat from that found in the plant. As such hydrolysis lignin can be further modified to solubilize the lignin as well as to increase the phenolic hydroxyl content. Also, the lignin products such as a residual pulping liquor may be subjected to various treatments such as, for example, acid, alkaline or heat treatments or reacted with the other chemicals which may further alter somewhat the lignin constituents. Illustrative sulfonated lignins can include, but are not limited to, sodium lignosulfonate and ammonium lignosulfonate.

The residual pulping liquors, or the lignin products produced in the separation or recovery of lignin from the plant matter can include lignin of various molecular weights of form about 300 to over 100,000. The liquors from which the lignin can be recovered can also include one or more other constituents besides the lignin. For example, in the sulfite pulping process, the spent sulfite liquor can include lignosulfonates that can be present as salts of cations, such as magnesium, calcium, ammonium, sodium and/or other cations. The spent sulfite liquor solids can include about 40 wt % to about 65 wt % lignosulfonates with the remainder being carbohydrates and other organic and inorganic constituents dissolved in the liquor. Lignin products produced by other pulping processes can also include other materials such as carbohydrates, degradation products of carbohydrates, and resinous materials which are separated from the cellulosic materials with the lignin. It should be noted that it is not necessary to separate the lignin from the other constituents that can be present.

The binder compositions can be combined with one or more second binders or adhesives in any desired amount with respect to one another to produce a binder system. For example, the amount of either the first binder composition or the second binder composition in the binder system can be from about 0.1 wt % to about 99 wt %, based on the combined solids weight of the first and second binder compositions. In another example, the binder system can have a concentration of the first binder composition in an amount of from a low of about 0.5 wt %, about 1 wt %, about 2 wt %, about 3 wt %, or about 4 wt % to a high of about 10 wt %, about 20 wt %, about 30 wt %, about 40 wt %, about 50 wt %, about 60 wt %, about 70 wt %, about 80 wt %, or about 90 wt %, based on the combined solids weight of the first and second binder compositions. In another example, the binder system can have a concentration of the first binder composition in an amount of about 10 wt % to about 90 wt % and a concentration of the second binder system of about 90 wt % to about 10 wt %, based on the combined solids weight of the first binder composition and the second binder composition.

The binder compositions can be free or essentially free of formaldehyde. As used herein, the term “essentially free of formaldehyde” means the binder composition does not include or contain any intentionally added formaldehyde or compounds that can decompose, react, or otherwise form formaldehyde. Said another way, the term “essentially free of formaldehyde” means the binder composition does not contain formaldehyde or compounds that can form formaldehyde, but may include formaldehyde present as an impurity. Accordingly, depending on the particular multifunctional aldehyde compound(s) used to produce the binder compositions discussed and described herein, the binder composition can be referred to as “no added formaldehyde” or “NAF” binder composition. The binder compositions can meet or exceed the formaldehyde emission standards required by the California Air Resources Board (“CARB”) Phase 1 (less than 0.18 parts per million “ppm” formaldehyde for particleboard), and Phase 2 (less than 0.09 ppm formaldehyde for particleboard). The binder compositions can also meet or exceed the formaldehyde emission standards required by the Japanese JIS/JAS F*** (does not exceed 0.5 mg/L formaldehyde for particleboard), Japanese JIS/JAS F**** (does not exceed 0.3 mg/L formaldehyde for particleboard), European E1, and European E2 standards.

As such, the composite wood products and/or the composite fiber products produced with the binder compositions and/or binder systems can exhibit a low level of formaldehyde emission. A suitable test for determining formaldehyde emission from a composite wood product that includes an at least partially cured binder composition and/or binder system can include ASTM D6007-02 and AST E1333-10. A suitable test procedure for determining formaldehyde emissions from fiber products that include an at least partially cured binder composition and/or binder system can include ASTM D5116-10 and ASTM D6670-01. According to such test methods, the composite wood products and/or the fiber products containing an at least partially cured binder composition and/or binder system can have a formaldehyde emission of zero. The composite wood products and/or the fiber products containing an at least partially cured binder composition and/or binder system can also have a formaldehyde emission of less than about 1 part per million (“ppm”), less than about 0.9 ppm, less than about 0.08 ppm, less than about 0.07 ppm, less than about 0.06 ppm, less than about 0.05 ppm, less than about 0.04 ppm, less than about 0.03 ppm, less than about 0.02 ppm, less than about 0.01 ppm, or less than about 0.005 ppm.

### EXAMPLES

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

### Example I

Black wattle tannin and glutaraldehyde were used to produce the binder compositions. The black wattle tannin was purchased from Bondtite Adhesives Ltd. and had product number 345. The glutaraldehyde was a 50 wt % aqueous solution and was purchased from Sigma Aldrich and had product number W512303.

A series of binder compositions (Ex. 1-6) were prepared by combining the black wattle tannin (50 wt % aqueous solution) with the glutaraldehyde (50 wt % aqueous solution) at varying weight ratios and the gel time of each example was then determined at three different pH levels (pH of 8, 9, and 10). Accordingly, the binder compositions of Ex. 1-6 were approximately 50 wt % aqueous solutions. A comparative example (C1) at the three pH levels (pH of 8, 9, and 10) was also prepared. The comparative example C1 was prepared by combining the black wattle tannin (50 wt % aqueous solution) with glyoxal (50 wt % aqueous solution) to provide a mixture containing about 91.8 wt % black wattle tannin and about 8.2 wt % glyoxal. The glyoxal was purchased from ACROS and had product number 156220025.

For each of examples 1-6, an approximately 15 g mixture was prepared in a 150 mL container by adding the appropriate amount of black wattle tannin and glutaraldehyde thereto to form the binder compositions. For the comparative example, an approximately 15 g mixture was prepared in a 150 mL container by adding the appropriate amount of black wattle tannin and glyoxal thereto to form the binder composition. Each example was monitored by an Orion 2 Star pH meter. At room temperature, each mixture (C1 and Ex. 1-6) was adjusted to the appropriate pH (8, 9, or 10) by adding a 50 wt % sodium hydroxide solution thereto. The particular amounts of each component combined to provide each of the examples (C1 and Ex. 1-6) are shown in Table 1 below.

TABLE 1
Binder Composition Preparation Amounts

| | | | 50 wt % aqueous |
|---|---|---|---|
| | 50 wt % aqueous | 40 wt % aqueous | solution of |
| | solution Black | solution of | Glutaraldehyde |
| Example | wattle tannin (g) | Glyoxal (g) | (g) |
| C1 | 13.5 | 1.5 | 0 |
| 1 | 14.25 | 0 | 0.75 |
| 2 | 13.8 | 0 | 1.2 |
| 3 | 13.5 | 0 | 1.5 |
| 4 | 13.2 | 0 | 1.8 |
| 5 | 12.75 | 0 | 2.25 |
| 6 | 12.0 | 0 | 3 |

A 10 g sample for each example (C1 and Ex. 1-6) was added to an 18×150 mm pyrex test tube. A wooden applicator stick (Fisher, 01-340) was inserted into the test tube. The gel meter was the Techne Incorporated's GT-4 gel meter. The “hold-operate” switch was placed in the “operate” position and the plunger on the gel meter was tapped to trigger the red light, so that the meter was in the stopped position. The “hold-operate” switch was then placed in the “hold” position and the “zero” button was pressed to clear the time display. The test tube was then placed into a boiling bath of water at 100° C., using the stopper for alignment and the “start” button was pressed. The wooden stick was connected to the plunger by inserting the top of the stick into the connector. The height of the sample was adjusted, by either adjusting the jack stand or moving the height of the meter, so that the stick was 0.25 inches from the bottom of the test tube at its lowest point, and in the middle of the test tube, not touching the sides. The “hold-operate” switch was positioned to “operate” to activate the gel-point sensor. The timer and motor automatically stopped when the gel point was reached and the time was recorded. Table 2 shows the gel time test results. The percent by weight (“wt %”) values are based on the combined weight of the tannin, i.e., black wattle tannin, and the multifunctional aldehyde, i.e., glyoxal or glutaraldehyde.

TABLE 2
Gel Test Results

| | Black | | | | | |
|---|---|---|---|---|---|---|
| | Wattle | | | Gel time | Gel time | Gel time |
| | Tannin | Glyoxal | Glutaraldehyde | at pH 8 | at pH 9 | at pH 10 |
| Example | (wt %) | (wt %) | (wt %) | (min) | (min) | (min) |
| C1 | 91.8 | 8.2 | 0.0 | Did not | Did not | Did not |
| | | | | gel in 30 min | gel in 30 min | gel in 30 min |
| 1 | 95.0 | 0.0 | 5.0 | 16.5 | 7.7 | 13 |
| 2 | 92.0 | 0.0 | 8.0 | 7.9 | 3.3 | 4.4 |
| 3 | 90.0 | 0.0 | 10.0 | 6.4 | 3 | 2.9 |
| 4 | 88.0 | 0.0 | 12.0 | 5.6 | 2.6 | 2.6 |
| 5 | 85.0 | 0.0 | 15.0 | 5.5 | 2.5 | 2.7 |
| 6 | 80.0 | 0.0 | 20.0 | 6.8 | 2.9 | 3.1 |

As shown in Table 1, the comparative example C1, which was a mixture of black wattle tannin and glyoxal, did not gel at all over a period of 30 minutes. Surprisingly and unexpectedly, the binder compositions for all of Examples 1-6 did gel. With the exception of Ex. 1, all other examples (Ex. 2-6) had a gel time of less than 10 minutes for all three pH values of 8, 9, and 10. Additionally, the binder composition of Examples 4 and 5 performed similarly and had the shortest gel time of the samples tested for the pH range of 8 to 10. Also as shown in Table 1, the gel time was reduced for the binder compositions when at a pH of 9 and 10 as compared to when the binder compositions had a pH of 8.

### Example II

To produce the binder composition used in Examples 7-16, the tannin and the multifunctional aldehyde were the same as in Example I. The binder compositions were again prepared by combining the appropriate amount of the black wattle tannin (50 wt % aqueous solution) with the glutaraldehyde (50 wt % aqueous solution) to provide binder compositions for Examples 7-16 all containing about 88 wt % black wattle tannin and about 12 wt % glutaraldehyde, based on the combined weight of the black wattle tannin and the glutaraldehyde. The pH was varied from a low of 1.1 to a high of 11.0 to determine the effect of pH on the gel time. Depending on the desired pH either a 50 wt % solution of NaOH or a concentrated HCl solution (concentration is 36.5-38%) was added to each of the black wattle tannin and glutaraldehyde mixtures. The particular amount of each component combined to provide each of Examples 7-16 are shown in Table 3 below. The same procedure for carrying out the gel test was used as in Example I. Table 3 also shows the gel time test results at differing pH levels.

TABLE 3

| | 50 wt % | | | |
|---|---|---|---|---|
| | aqueous | 50 wt % | | |
| | solution Black | aqueous | | |
| | wattle tannin | Glutaraldehyde | | Gel time |
| Example | (g) | (g) | pH | (min) |
| 7 | 13.2 | 1.8 | 1.1 | 5.6 |
| 8 | 13.2 | 1.8 | 2.2 | Did not gel in |
| | | | | 30 min |
| 9 | 13.2 | 1.8 | 3.1 | Did not gel in |
| | | | | 30 min |
| 10 | 13.2 | 1.8 | 4.1 | Did not gel in |
| | | | | 30 min |
| 11 | 13.2 | 1.8 | 5.4 | Did not gel in |
| | | | | 30 min |
| 12 | 13.2 | 1.8 | 7.1 | 27.3 |
| 13 | 13.2 | 1.8 | 8.2 | 5.6 |
| 14 | 13.2 | 1.8 | 9.1 | 2.6 |
| 15 | 13.2 | 1.8 | 10.2 | 2.6 |
| 16 | 13.2 | 1.8 | 11 | Did not gel in |
| | | | | 30 min |

As shown in Table 3, a pH between about 9.1 and 10.2 yielded the fastest gel time for the binder composition containing 88 wt % black wattle tannin and 12 wt % glutaraldehyde. When the pH of the binder composition was between about 2 and somewhere between about 6 and 7, the binder compositions did not gel in 30 minutes. Accordingly, the pH of the binder composition can be increased to about 7 or more to produce binder compositions that gel within 30 minutes.

### Example III

An automated bonding and evaluation system (ABES) test was conducted to evaluate the mechanical response, i.e., bond strength, of the binder composition prepared according to Examples I and II that contained 88 wt % tannin and 12 wt % glutaraldehyde. Four binder compositions having a pH of 9, 10, 11, and 12 were prepared. The pH was adjusted as discussed above in Example I using a 50 wt % sodium hydroxide solution. Table 4 below shows the amounts of each component combined with one another to produce the binder compositions of Examples 17-20.

TABLE 4
Binder Composition Preparation Amounts

| | 50 wt % aqueous | | |
|---|---|---|---|
| | solution Black wattle | 50 wt % aqueous | |
| Example | tannin (g) | Glutaraldehyde (g) | pH |
| 17 | 13.2 | 1.8 | 9 |
| 18 | 13.2 | 1.8 | 10 |
| 19 | 13.2 | 1.8 | 11 |
| 20 | 13.2 | 1.8 | 12 |

The binder compositions of Examples 17-20 were applied to the ends of a pair of maple veneer strips that were mounted on an ABES and pressed at 100° C. and a pressure of 1.2 N/mm² for a varying times (20, 45, 60, 90, or 120 seconds) and then pulled apart from each other to measure the shear strength. The ABES test was conducted according to the test procedure discussed and described in C. Heinemann et al., “Kinetic Response of Thermosetting Adhesive Systems to Heat: Physico-Chemical Versus Mechanical Responses,” in Proc. 6th Pacific Rim Bio-Based Composites Symposium, Portland/USA, Oregon State University 2002, Vol. 1, S. 34-44. The results are shown in Table 5 below and each data point is the average of 3 tests.

TABLE 5
ABES Test

| | | MaxStress | MaxStress | MaxStress | MaxStress | MaxStress |
|---|---|---|---|---|---|---|
| Example | pH | (MPa), 20 sec. | (MPa), 45 sec. | (MPa), 60 sec. | (MPa), 90 sec. | (MPa), 120 sec. |
| 17 | 9 | 2.01 | 2.42 | 2.4 | 2.82 | 2.83 |
| 18 | 10 | 3.21 | 3.94 | 3.92 | 3.94 | 3.94 |
| 19 | 11 | 2.35 | 3.28 | 4.06 | 4.14 | 4.12 |
| 20 | 12 | 1.62 | 3.1 | 3.48 | 3.57 | 3.75 |

As shown in Table 4, the binder composition of Ex. 19 that had a pH of 11 provided the greatest bond strength at a cure time of 60 seconds or more. However, all of Ex. 17-20 exhibited adequate bond strength at all press times.

### Example IV

A dynamic mechanical analysis (DMA) test was conducted to evaluate the mechanical response, i.e., bond strength, of the binder composition prepared according to Examples I and II that contained 88 wt % tannin and 12 wt % glutaraldehyde. Five binder compositions having a pH of 8, 9, 10, 11, and 12 were prepared. The pH was adjusted as discussed above in Example I using a 50 wt % sodium hydroxide solution. Table 6 below shows the amount of each component combined with one another to produce the binder compositions of Examples 21-25.

TABLE 6
Binder Composition Preparation Amounts

| | 40 wt % aqueous | | |
|---|---|---|---|
| | solution Black wattle | 50 wt % aqueous | |
| Example | tannin (g) | Glutaraldehyde (g) | pH |
| 21 | 16.5 | 1.8 | 8 |
| 22 | 16.5 | 1.8 | 9 |
| 23 | 16.5 | 1.8 | 10 |
| 24 | 16.5 | 1.8 | 11 |
| 25 | 16.5 | 1.8 | 12 |

The binder compositions of Examples 21-25 were applied to 4 plys of fiberglass braid that were mounted on an DMA, with a 20 mm amplitude, and 20 Hertz setting. The heating ramp rate was 10° C. per minute. The results are shown in Table 7 below.

TABLE 7
DMA Test

| | | | | Loss modulus |
|---|---|---|---|---|
| Example | pH | Onset of cure (° C.) | End of cure (° C.) | max (° C.) |
| 21 | 8 | 148 | 158 | 156 |
| 22 | 9 | 113 | 158 | 148 |
| 23 | 10 | 95 | 156 | 127 |
| 24 | 11 | 92 | 159 | 123 |
| 25 | 12 | 86 | 161 | 135 |

### Example V

The pot life (viscosity over time) for the binder composition that contained 88 wt % black wattle tannin and 12 wt % glutaraldehyde (prepared as in Example I) at a pH of about 9 (Ex. 26) and a pH of about 10 (Ex. 27) was determined. Additionally, the pot life for a comparative example 2 (C2) that contained only the black wattle tannin (the same as in Example I) at a pH of about 10 and as a 50 wt % aqueous solution was also determined. The binder compositions of Ex. 21 and 22 and the black wattle tannin of C2 were transferred to a sample holder of a Brookfield (model DV-II+) viscometer, and the viscosity was recorded at a time of 1, 2, 3, 5, 7, 10, 15, 20, and 30 minutes. A 15 mL sample container and a No. 31 spindle were used to conduct the viscosity test. The viscosity tests were measured at 25° C. The results of the viscosity test over 30 minutes are shown in Table 8 below.

TABLE 8
Viscosity Change Over Time

| | | | | | | Viscosity | Viscosity | Viscosity | Viscosity |
|---|---|---|---|---|---|---|---|---|---|
| | Viscosity | Viscosity | Viscosity | Viscosity | Viscosity | (cP) at | (cP) at | (cP) at | (cP) at |
| Example | (cP) at 1 min | (cP) at 2 min | (cP) at 3 min | (cP) at 5 min | (cP) at 7 min | 10 min | 15 min | 20 min | 30 min |
| 26 | 1,320 | 1,500 | 1,656 | 1,986 | 2,328 | 2,910 | 4,140 | 5,502 | 10,930 |
| 27 | not | 1,644 | 1,890 | 2,346 | 2,718 | 3,324 | 4,356 | 5,748 | 11,410 |
| | determined | | | | | | | | |
| C2 | 252 | 270 | 306 | 384 | 390 | 378 | 384 | 384 | 432 |

As shown in Table 8, the viscosity of binder compositions of Ex. 26 and 27 did not increase to about 10,000 cP until sometime between 20 and 30 minutes.

### Example VI

The effect that cooling had on the pot life of the binder composition (Ex. 28) that contained 88 wt % black wattle tannin and 12 wt % glutaraldehyde (prepared as in Example I) at a pH of about 9 was determined. The result of cooling is compared to a comparative example (C3) that had the same composition as Ex. 28, but was not subjected to cooling. Ex. 28 was cooled and maintained at a temperature of about 0° C. during the pH adjustment and before the viscosity test. The viscosity was determined as discussed above in Example IV. The results are shown in Table 9 below.

TABLE 9
Effect of Cooling on Viscosity

| Time, min. | C3 | Ex. 28 |
|---|---|---|
| 1 | 1,320 | 756 |
| 2 | 1,500 | 756 |
| 3 | 1,656 | 762 |
| 5 | 1,986 | 858 |
| 7 | 2,328 | 1,014 |
| 10 | 2,910 | 1,314 |
| 15 | 4,140 | 1,944 |
| 20 | 5,502 | 2,802 |
| 30 | 10,930 | 5,478 |

As shown in Table 9, cooling the binder composition reduces the increase in viscosity over time by approximately 50%.

### Example VII

Two particleboard studies were conducted to determine the internal bond strength (“IB”) in pounds per square inch (“psi”) and average density in pounds per cubic foot (“pcf”). Four binder compositions (Ex. 29-32) were prepared, each contained about 88 wt % black wattle tannin and about 12 wt % glutaraldehyde. The pH for Ex. 29-32 were 12.1, 11, 10, and 9, respectively. The pH was adjusted as discussed above in Example I using a 50 wt % sodium hydroxide solution. Table 10 below shows the amount of each component combined with one another to produce the binder compositions of Examples 29-32.

TABLE 10
Binder Composition Preparation Amounts

| | 50 wt % aqueous | 50 wt % aqueous | 50 wt % | |
|---|---|---|---|---|
| | solution Black | Glutaraldehyde | aqueous | |
| Example | wattle tannin (g) | (g) | NaOH (g) | pH |
| 29 | 585.5 | 79.8 | 154.4 | 12.1 |
| 30 | 585.5 | 79.8 | 118.4 | 11 |
| 31 | 585.5 | 79.8 | 88.7 | 10 |
| 32 | 585.5 | 79.8 | 44.2 | 9 |

For the first particleboard study, southern yellow pine wood furnish (3,571 g, moisture content 6.86 wt %) was added to a ribbon blender. Under mechanical blending, the binder composition, i.e., mixture of black wattle tannin (585.5 g of 50 wt % concentration) and glutaraldehyde (79.8 g, 50 wt % concentration) having the desired pH that was adjusted using the appropriate amount of a 50% sodium hydroxide solution, was sprayed to the ribbon blender through an atomizer. The amount of binder composition added to the wood furnish to produce each particleboard sample was 10 wt %, based on the dry weight of the wood furnish. A wax solution (17.2 g) was then sprayed onto the wood furnish. After the moisture content of the wood furnish/binder compositions was measured (14.18%), 2,349 g of the furnish-binder mix was homogeneously spread into a 16 inch by 16 inch mat forming frame and then manually pre-pressed. The mat forming frame was removed to provide a pre-pressed or consolidated mat. The consolidated mat was placed into a hot press at a temperature of about 330° F. and subjected to pressure for about 8 minutes. A three-step pressing program was used for the particleboard production. In the first step, the pressure reached about 640 psi after about 7 seconds while pressing the panels to a final panel thickness of about 0.620 in. In the second step, the pressure was decreased gradually to about 260 psi during the remainder of the pressing cycle. In the third step, a 30 second decompression time at a set thickness of about 0.635 in was used at the end of the process.

The particleboard was then cut into 2 inch by 2 inch blocks that had a varying thickness depending on the degree each board was compacted in the press. The weights were measured to determine the average density. The internal bond strength for each example was measured and determined according to the test procedure provided for in ASTM D1037-06a. Accordingly, for the first particleboard study four particleboards were made (Ex. 24, 25, 26, and 27) at a pH of 12.1, 11, 10, and 9, respectively. The results are shown in Table 11 below.

TABLE 11
First Particleboard Test

| | | | Average Density |
|---|---|---|---|
| Example | pH | Average IB (psi) | (pcf) |
| 29 | 12.1 | 116 ± 16 | 54.3 ± 1.5 |
| 30 | 11 | 85 ± 21 | 53.7 ± 1.8 |
| 31 | 10 | 125 ± 27 | 54.2 ± 1.2 |
| 32 | 9 | 97 ± 28 | 53.8 ± 1.2 |

For the second particleboard test, seven additional particleboard samples (Ex. 33-39) were made using the same procedure as in the first particleboard test except the press temperature was increased to 400° F. and the press time varied between 2.5 minutes and 6 minutes, with the press times shown in Table 13 below. The pH of the binder composition for Ex. 33-39 was maintained at about 10.2 to about 10.3. Table 12 below shows the amount of each component combined with one another to produce the binder compositions of Examples 33-39.

TABLE 12
Binder Composition Preparation Amounts

| | 50 wt % aqueous | 50 wt % aqueous | |
|---|---|---|---|
| | solution Black | Glutaraldehyde | 50 wt % aqueous |
| Example | wattle tannin (g) | (g) | NaOH (mL) |
| 33 | 1170.8 | 159.7 | 176.8 |
| 34 | 1170.8 | 159.7 | 176.8 |
| 35 | 1170.8 | 159.7 | 176.8 |
| 36 | 1170.8 | 159.7 | 176.8 |
| 37 | 1170.8 | 159.7 | 169.0 |
| 38 | 1170.8 | 159.7 | 169.0 |
| 39 | 1170.8 | 159.7 | 169.0 |

The results for the second particleboard test were determined as in the first particleboard test and are shown in Table 13 below.

TABLE 13
Second Particleboard Test

| | | Press time | | Average density |
|---|---|---|---|---|
| Example | pH | (min) | Average IB (psi) | (pcf) |
| 33 | 10.3 | 3.5 | 108 ± 19 | 49.0 ± 1.1 |
| 34 | 10.3 | 3 | 101 ± 27 | 49.9 ± 1.5 |
| 35 | 10.3 | 2.5 | 77 ± 13 | 49.9 ± 1.1 |
| 36 | 10.3 | 6 | 99 ± 22 | 49.5 ± 2.6 |
| 37 | 10.2 | 6 | 75 ± 18 | 44.2 ± 1.1 |
| 38 | 10.2 | 5 | 101 ± 24 | 49.6 ± 1.7 |
| 39 | 10.2 | 4 | 65 ± 24 | 48.2 ± 1.7 |

As shown in Tables 10 and 11, the binder composition produced particleboards that exhibited internal bond strengths of 65 psi or more.

Embodiments of the present disclosure further relate to any one or more of the following paragraphs:

1. A composite product, comprising: a plurality of substrates and an at least partially cured binder composition, wherein the binder composition, prior to curing, comprises: one or more tannins; and one or more multifunctional aldehyde compounds comprising: (1) three or more carbon atoms and two or more aldehyde functional groups, or (2) two or more carbon atoms, at least one aldehyde functional group, and at least one functional group other than an aldehyde functional group, wherein a carbon atom of at least one aldehyde functional group in the cured binder composition has a first bond with a first tannin molecule of the one or more tannins and a second bond with (a) the first tannin molecule, (b) a second tannin molecule of the one or more tannins, or (c) an oxygen atom of the at least one aldehyde functional group.

2. A method for making a composite product, comprising: contacting a plurality of substrates with a binder composition, wherein the binder composition comprises: one or more tannins; and one or more multifunctional aldehyde compounds comprising: (1) three or more carbon atoms and two or more aldehyde functional groups, or (2) two or more carbon atoms, at least one aldehyde functional group, and at least one functional group other than an aldehyde functional group; and at least partially curing the binder composition to provide a composite product, wherein a carbon atom of at least one aldehyde functional group in the cured binder composition has a first bond with a first tannin molecule of the one or more tannins and a second bond with (a) the first tannin molecule, (b) a second tannin molecule of the one or more tannins, or (c) an oxygen atom of the at least one aldehyde functional group.

3. A binder composition comprising one or more tannins and one or more multifunctional aldehyde compounds, wherein the one or more multifunctional aldehyde compounds comprises: (1) three or more carbon atoms and two or more aldehyde functional groups, or (2) two or more carbon atoms, at least one aldehyde functional group, and at least one functional group other than an aldehyde functional group.

4. A cured binder composition comprising one or more tannins and one or more multifunctional aldehyde compounds, wherein the one or more multifunctional aldehyde compounds comprises: (1) three or more carbon atoms and two or more aldehyde functional groups, or (2) two or more carbon atoms, at least one aldehyde functional group, and at least one functional group other than an aldehyde functional group, and wherein a carbon atom of at least one aldehyde functional group in the cured binder composition has a first bond with a first tannin molecule of the one or more tannins and a second bond with (a) the first tannin molecule, (b) a second tannin molecule of the one or more tannins, or (c) an oxygen atom of the at least one aldehyde functional group.

5. The composite product, method, binder composition, or cured binder composition according to any one of paragraphs 1 to 4, wherein the at least one functional group other than an aldehyde functional group is selected from the group consisting of: a carboxylic acid group, an ester group, an amide group, an imine group, an epoxide group, an aziridine group, an azetidinium group, and a hydroxyl group.

6. The composite product or method according to any one of paragraphs 1 to 5, wherein the one or more tannins is present in an amount of from about 60 wt % to about 99 wt %, based on a total weight of the one or more tannins and the one or more multifunctional aldehyde compounds.

7. The composite product or method according to any one of paragraphs 1 to 6, wherein the one or more tannins is present in an amount of from about 80 wt % to about 95 wt %, based on a total solids weight of the one or more tannins and the one or more multifunctional aldehyde compounds.

8. The composite or method according to any one of paragraphs 1 to 7, wherein the one or more tannins and the one or more multifunctional aldehyde compounds are combined with one another in a liquid medium.

9. The composite product or method according to paragraph 8, wherein the liquid medium comprises water, and wherein the binder composition has a concentration of water of from about 1 wt % to about 70 wt %, based on a total weight of the one or more tannins, the one or more multifunctional aldehyde compounds, and the liquid medium.

10. The composite product or method according to any one of paragraphs 1 to 9, wherein the binder composition is essentially free of formaldehyde.

11. The composite product or method according to any one of paragraphs 1 to 10, wherein the one or more tannins is extracted from one or more trees belonging to the genera selected from the group consisting of: Castanea sativa, Terminalia, Phyllantus, Caesalpina coriaria, Caesalpinia spinosa, Acacia mearnsii, Schinopsis, Tsuga, Rhus, Pinus, Carya, and Juglans.

12. The composite product or method according to any one of paragraphs 1 to 11, wherein the one or more multifunctional aldehyde compounds comprises glutaraldehyde, glyoxylic acid, malondialdehyde, adipaldehyde, phthalaldehyde, 5-(hydroxymethyl)furfural, or any mixture thereof.

13. The composite product or method according to any one of paragraphs 1 to 12, wherein the multifunctional aldehyde compound is blocked with a blocking agent.

14. The composite product or method according to paragraph 13, wherein the blocking agent comprises urea, one or more cyclic ureas, one or more glycols, one or more polyols, or any mixture thereof.

15. The composite product or method according to any one of paragraphs 1 to 14, wherein the binder composition further comprises one or more base compounds.

16. The composite product or method according to paragraph 15, wherein the one or more base compounds comprises potassium hydroxide, potassium carbonate, sodium hydroxide, sodium carbonate, or any mixture thereof.

17. The composite product or method according to any one of paragraphs 1 to 16, wherein the plurality of substrates comprise lignocellulose substrates, glass fibers, or any mixture thereof.

18. The composite product or method according to any one of paragraphs 1 to 17, wherein the composite product is a particleboard, a fiberboard, a plywood, an oriented strand board, a laminated veneer lumber, a laminated veneer board, or a non-woven fiberglass mat.

19. The composite product or method according to any one of paragraphs 1 to 18, wherein the binder composition is a component of a binder system, and wherein the binder system comprises a second binder composition.

20. The composite product or method according to paragraph 19, wherein the second binder composition comprises an aldehyde based resin; a mixture of Maillard reactants; a reaction product of Maillard reactants; a copolymer of one or more vinyl aromatic derived units and at least one of maleic anhydride and maleic acid; a polyamidoamine-epichlorhydrin polymer; a mixture of a polyamidoamine and ammonia-epichlorhydrin adduct binder; a mixture of a polyamidoamine-epichlorhydrin polymer and at least one of a soy protein, a wheat protein, a pea protein, a corn protein, and a guar protein; an adduct or polymer of styrene, at least one of maleic anhydride and maleic acid, and at least one of an acrylic acid and an acrylate; a polyacrylic acid based binder; polyvinyl acetate; polymeric methylene diisocyanate; starch; soy protein, lignin; or any combination thereof.

21. The method according to any one of paragraphs 2, or 5 to 18, wherein the one or more tannins, the one or more multifunctional aldehyde compounds, or both is encapsulated in a plurality of capsules.

22. The method according to paragraph 21, further comprising fracturing at least a portion of the capsules to cause direct contact between the one or more tannins and the one or more multifunctional aldehyde compounds.

23. The method according to any one of paragraphs 2 or 5 to 22, further comprising combining a second binder composition with the binder composition to provide a binder system, wherein the plurality of substrates is contacted with the binder system.

24. The method according to paragraph 23, wherein the second binder composition comprises an aldehyde based resin; a mixture of Maillard reactants; a reaction product of Maillard reactants; a copolymer of one or more vinyl aromatic derived units and at least one of maleic anhydride and maleic acid; a polyamidoamine-epichlorhydrin polymer; a mixture of a polyamidoamine and ammonia-epichlorhydrin adduct binder; a mixture of a polyamidoamine-epichlorhydrin polymer and at least one of a soy protein, a wheat protein, a pea protein, a corn protein, and a guar protein; an adduct or polymer of styrene, at least one of maleic anhydride and maleic acid, and at least one of an acrylic acid and an acrylate; a polyacrylic acid based binder; polyvinyl acetate; polymeric methylene diisocyanate; starch; soy protein, lignin; or any combination thereof.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A composite product, comprising:
a plurality of substrates and an at least partially cured binder composition, wherein the binder composition, prior to curing, comprises:
one or more tannins; and
one or more multifunctional aldehyde compounds comprising:
(1) three or more carbon atoms and two or more aldehyde functional groups, or
(2) two or more carbon atoms, at least one aldehyde functional group,
and at least one functional group other than an aldehyde functional group, wherein a carbon atom of at least one aldehyde functional group in the cured binder composition has a first bond with a first tannin molecule of the one or more tannins and a second bond with (a) the first tannin molecule, (b) a second tannin molecule of the one or more tannins, or (c) an oxygen atom of the at least one aldehyde functional group.

2. The composite product of claim 1, wherein the at least one functional group other than an aldehyde functional group is selected from the group consisting of: a carboxylic acid group, an ester group, an amide group, an imine group, an epoxide group, an aziridine group, an azetidinium group, and a hydroxyl group.

3. The composite product of claim 1, wherein the one or more tannins is present in an amount of from about 60 wt % to about 99 wt %, based on a total weight of the one or more tannins and the one or more multifunctional aldehyde compounds.

4. The composite product of claim 1, wherein the one or more tannins is present in an amount of from about 80 wt % to about 95 wt %, based on a total solids weight of the one or more tannins and the one or more multifunctional aldehyde compounds.

5. The composite product of claim 1, wherein the one or more tannins and the one or more multifunctional aldehyde compounds are combined with one another in a liquid medium.

6. The composite product of claim 5, wherein the liquid medium comprises water, and wherein the binder composition has a concentration of water of from about 1 wt % to about 70 wt %, based on a total weight of the one or more tannins, the one or more multifunctional aldehyde compounds, and the liquid medium.

7. The composite product of claim 1, wherein the binder composition is essentially free of formaldehyde.

8. The composite product of claim 1, wherein the one or more tannins is extracted from one or more trees belonging to the genera selected from the group consisting of: Castanea sativa, Terminalia, Phyllantus, Caesalpina coriaria, Caesalpinia spinosa, Acacia mearnsii, Schinopsis, Tsuga, Rhus, Pinus, Carya, and Juglans.

9. The composite product of claim 1, wherein the one or more multifunctional aldehyde compounds comprises glutaraldehyde, glyoxylic acid, malondialdehyde, adipaldehyde, phthalaldehyde, 5-(hydroxymethyl)furfural, or any mixture thereof.

10. The composite product of claim 1, wherein the multifunctional aldehyde compound is blocked with a blocking agent.

11. The composite product of claim 12, wherein the blocking agent comprises urea, one or more cyclic ureas, one or more glycols, one or more polyols, or any mixture thereof.

12. The composite product of claim 1, wherein the binder composition further comprises one or more base compounds.

13. The composite product of claim 14, wherein the one or more base compounds comprises potassium hydroxide, potassium carbonate, sodium hydroxide, sodium carbonate, or any mixture thereof.

14. The composite product of claim 1, wherein the plurality of substrates comprise lignocellulose substrates, glass fibers, or a mixture thereof.

15. The composite product of claim 1, wherein the composite product is a particleboard, a fiberboard, a plywood, an oriented strand board, a laminated veneer lumber, a laminated veneer board, or a non-woven fiberglass mat.

16. The composite product of claim 1, wherein the binder composition is a component of a binder system, and wherein the binder system comprises a second binder composition.

17. The composite product of claim 18, wherein the second binder composition comprises an aldehyde based resin; a mixture of Maillard reactants; a reaction product of Maillard reactants; a copolymer of one or more vinyl aromatic derived units and at least one of maleic anhydride and maleic acid; a polyamidoamine-epichlorhydrin polymer; a mixture of a polyamidoamine and ammonia-epichlorhydrin adduct binder; a mixture of a polyamidoamine-epichlorhydrin polymer and at least one of a soy protein, a wheat protein, a pea protein, a corn protein, and a guar protein; an adduct or polymer of styrene, at least one of maleic anhydride and maleic acid, and at least one of an acrylic acid and an acrylate; a polyacrylic acid based binder; polyvinyl acetate; polymeric methylene diisocyanate; starch; soy protein, lignin; or any combination thereof.

18. A method for making a composite product, comprising:
contacting a plurality of substrates with a binder composition, wherein the binder composition comprises:
one or more tannins; and
one or more multifunctional aldehyde compounds comprising:
(1) three or more carbon atoms and two or more aldehyde functional groups, or
(2) two or more carbon atoms, at least one aldehyde functional group,
and at least one functional group other than an aldehyde functional group; and at least partially curing the binder composition to provide a composite product, wherein a carbon atom of at least one aldehyde functional group in the cured binder composition has a first bond with a first tannin molecule of the one or more tannins and a second bond with (a) the first tannin molecule, (b) a second tannin molecule of the one or more tannins, or (c) an oxygen atom of the at least one aldehyde functional group.

19. The method of claim 18, wherein the one or more tannins, the one or more multifunctional aldehyde compounds, or both is encapsulated in a plurality of capsules, the method further comprising fracturing at least a portion of the capsules to cause direct contact between the one or more tannins and the one or more multifunctional aldehyde compounds.

20. The method of claim 18, further comprising combining a second binder composition with the binder composition to provide a binder system, wherein the plurality of substrates is contacted with the binder system, and wherein the second binder composition comprises an aldehyde based resin; a mixture of Maillard reactants; a reaction product of Maillard reactants; a copolymer of one or more vinyl aromatic derived units and at least one of maleic anhydride and maleic acid; a polyamidoamine-epichlorhydrin polymer; a mixture of a polyamidoamine and ammonia-epichlorhydrin adduct binder; a mixture of a polyamidoamine-epichlorhydrin polymer and at least one of a soy protein, a wheat protein, a pea protein, a corn protein, and a guar protein; an adduct or polymer of styrene, at least one of maleic anhydride and maleic acid, and at least one of an acrylic acid and an acrylate; a polyacrylic acid based binder; polyvinyl acetate; polymeric methylene diisocyanate; starch; soy protein, lignin; or any combination thereof.
